(19) United States
(12) Patent Application Publication
(10) Pub. No.: US 2024/0405682 A1
(43) Pub. Date: Dec. 5, 2024

(54) BIDIRECTIONAL HYBRID POWER CONVERSION SYSTEM

(71) Applicant: CHIP-GAN POWER SEMICONDUCTOR CORPORATION, HSINCHU CITY (TW)

(72) Inventors: KE-HORNG CHEN, HSINCHU CITY (TW); KE-MING SU, HSINCHU CITY (TW); YU-CHOU KO, HSINCHU CITY (TW); KUO-LIN ZHENG, HSINCHU CITY (TW); YING-FENG WU, HSINCHU CITY (TW)

(21) Appl. No.: 18/508,458

(22) Filed: Nov. 14, 2023

(30) Foreign Application Priority Data
Jun. 2, 2023 (TW) 112120704

(51) Int. Cl. H02M 3/158; H02M 1/00

(52) U.S. Cl. CPC H02M 3/1584; H02M 1/0067; H02M 1/0095

(57) ABSTRACT

A bidirectional hybrid power conversion system includes a symmetric hybrid unit, a transient state detection unit, a conversion control unit, and a feedback unit. The symmetric hybrid unit converts an input voltage into an output voltage with different conversion ratios. The feedback unit generates a feedback signal according to the output voltage and a reference voltage. The conversion control unit is connected with the symmetric hybrid unit and the feedback unit controls the symmetric hybrid unit to adjust the conversion ratio for regulating the output voltage according to the feedback signal. The transient state detection unit is connected with the feedback unit and the conversion control unit outputs a detection signal to the conversion unit according to the feedback signal. According to the detection signal, the conversion control unit controls the symmetric hybrid unit adjusts the conversion ratio, and converts the input voltage into the output voltage stably.

### BACKGROUND OF THE INVENTION

This application claims priority for the TW patent application No. 112120704 filed on 2 Jun. 2023, the content of which is incorporated by reference in its entirely.

### FIELD OF THE INVENTION

The present invention relates to a power conversion system, particularly to a hybrid power conversion system, which is able to buck and boost voltage bidirectionally, able to adapt itself to the variation of voltage/load to output voltage stably, and able to respond fast to the transient variation during voltage conversion.

### DESCRIPTION OF THE PRIOR ART

Because more and more consumer electronics adopt USB Power Delivery (abbreviated as USB PD) as the transmission medium of power and data, USB PD has played an increasingly important role in consumer electronics in recent years.

The USB Power Delivery Specification Revision 3.1, Version 1.0 (abbreviated as USB PD 3.1) expands the voltage transmitted thereby to as high as 48 volts (48V). Thus, a buck-boost converter needs to have an extreme conversion ratio (CR), wherein CR=output voltage (Vₒᵤₜ)/input voltage (Vᵢₙ). Since CR varies in such a range from 0.1 to 10, a buck-boost converter should be adaptive to high voltage stress switching and fast transient response.

The USB Type-C connector that meets the USB PD 3.1 specification allows a single port to transmit power. Thus, a power converter becomes a bidirectional power transmission instrument. In order to realize bidirectional power transmission, a common measure is arranging two power converters in each direction. However, this measure is very expensive and makes the design of the controller complicated.

Refer to FIG. 1 for a conventional three-level buck-boost converter (TLBB). The conventional three-level buck-boost converter can raise and lower voltage while V₂>2V₁. While the Vₓ of a node is twice V₁, the inductors L of the φ1 and φ2 voltage conversion circuits of the three-level buck-boost converter will be charged simultaneously. Thus, the three-level buck-boost converter is unlikely to transfer power from V2 to V1.

Refer to FIG. 2 for a conventional double step-down converter DSD). In DSD, V1 needs to be four times V2 so as to transfer power from V2 to V1 because of the limitation of CR. However, the existing DC to DC converter is hard to realize a wide CR range and a bidirectional power conversion.

Some conventional buck-boost converters may achieve a full-range CR. However, while the power is converted from 48V to 5V, the CR will be equal to 0.1. This situation would lead to difficulties in designing the driver and controller. Refer to FIG. 3. A double step-down converter can provide an extreme conversion ratio (from 24V to 1V) and has a wider duty cycle. However, the maximum conversion ratio of the double step-down converter is limited to 0.25, which does not meet the requirement of USB PD 3.1. Regarding boost conversion, some hybrid boost converters support a conversion ratio greater than 4. However, they cannot yet satisfy the requirement of USB PD 3.1. The conventional buck-boost converter can operate in a voltage bucking mode and a voltage boosting mode. However, the maximum conversion ratio thereof is only 2. The input voltage and output voltage of USB PD vary between 5V and 48V. Therefore, the conventional hybrid has a high voltage stress over 96V (2×Vin). The conventional three-level buck-boost converter and the conventional buck-boost converter have a high voltage stress over 48V. Therefore, it is inevitable to adopt a measure to handle 60V high voltage. However, such a solution will increase the fabrication cost of buck-boost converters and decrease the efficiency of buck-boost converters.

According to the above description, various types of conventional power converters are hard to achieve the conversion ratio required by the USB PD specification. Alternatively, the manufacturers have to spend higher costs to achieve a sufficient conversion ratio. Therefore, the manufacturers are eager to develop a power converter capable for meeting the demand of USB PD 3.1 and able to realize bidirectional power transmission.

### SUMMARY OF THE INVENTION

Considering the conventional problems, one objective of the present invention is to provide a power conversion system to perform power conversion at a high conversion ratio. The system can also perform bidirectional voltage conversion at different conversion ratios. The system can further meet the demand for USB PD 3.1. Furthermore, the system is exempted from the problem of sudden voltage rise or sudden voltage drop in the transient state. Moreover, the system can accurately buck or boost voltage to avoid the problems induced by incorrectly switching the voltage conversion modes.

According to the objective of the present invention, the present invention provides a bidirectional hybrid power conversion system, which comprises a symmetric hybrid unit, a feedback unit, and a conversion control unit. The symmetric hybrid unit converts an input voltage into an output voltage at the original conversion ratio or a different conversion ratio selectively. The feedback unit is connected to the symmetric hybrid unit and generates a feedback signal according to the output voltage and a reference voltage. The conversion control unit is connected between the symmetric hybrid unit and the feedback unit. According to the feedback signal, the input signal, and the output signal, the conversion control unit generates a control signal. The conversion control unit utilizes the control signal to control the symmetric hybrid unit to maintain or modify the conversion ratio. The conversion control unit enables the symmetric hybrid unit to stably convert the input voltage into the output voltage.

The symmetric hybrid unit includes a first conversion regulation circuit, a second conversion regulation circuit, and an intermediate circuit. The intermediate circuit is disposed between the first conversion regulation circuit and the second conversion regulation circuit. A maximum boost conversion ratio, which can be achieved by the first conversion regulation circuit, the intermediate circuit, and the second conversion regulation circuit, may be expressed by an equation:

$$\\ \frac{{V}_{OUT}}{{V}_{IN}} = {CR}_{2 - x boost} = \frac{2}{1 - D}$$

A maximum buck conversion ratio, which may be achieved by the first conversion regulation circuit, the intermediate circuit, and the second conversion regulation circuit, can be expressed by an equation:

$$\\ \frac{{V}_{OUT}}{{V}_{IN}} = {CR}_{2 - x buck} = \frac{D}{2}$$

wherein V_{OUT} is the output voltage; V_{IN} is the input voltage; CR_{2-x boost} is the maximum boost conversion ratio; CR_{2-x buck} is the maximum buck conversion ratio; D is the duty cycle of the first conversion regulation circuit and the second conversion regulation circuit. According to the control signal, the conversion control unit controls the voltage conversion ratio of the symmetric hybrid unit between the maximum boost conversion ratio and the maximum buck conversion ratio.

The feedback unit includes a multiplexer, a reference voltage generation circuit, and a comparator. The multiplexer is connected to the first conversion regulation circuit and the second conversion regulation circuit. While the first conversion regulation circuit functions as the output side, the multiplexer receives the voltage output by the first conversion regulation circuit. While the second conversion regulation circuit functions as the output side, the multiplexer receives the voltage output by the second conversion regulation circuit. The reference voltage generation circuit generates a reference voltage. The comparator is connected with the multiplexer and the reference voltage generation circuit, receiving the reference voltage and the output voltage, and comparing the reference voltage and the output voltage to output a feedback signal.

A first regulation voltage between the first conversion regulation circuit and the intermediate circuit. A second regulation voltage between the second conversion regulation circuit and the intermediate circuit.

The voltage relationships of the first regulation voltage and the second regulation voltage in five different phases are respectively expressed by

$$\\ {φ}_{A} : {V}_{x 1} = \frac{2 {V}_{IN}}{3} , {V}_{x 2} = \frac{2 {V}_{OUT}}{3} ; {φ}_{B} : {V}_{x 1} = GND , {V}_{x 2} = \frac{2 {V}_{OUT}}{3} ;$$

$$\\ {φ}_{C} : {V}_{x 1} = \frac{{V}_{IN}}{3} , {V}_{x 2} = \frac{2 {V}_{OUT}}{3} ; {φ}_{D} : {V}_{x 1} = \frac{2 {V}_{IN}}{3} , {V}_{x 2} = GND ; {}_{} and$$

$$\\ {φ}_{E} : {V}_{x 1} = \frac{2 {V}_{IN}}{3} , {V}_{x 2} = \frac{{V}_{OUT}}{3}$$

wherein Vₓ₁ is the first regulation voltage; Vₓ₂ is the second regulation voltage; φ_{A} is the first phase; φ_{B} is the second phase; φ_{C} is the third phase; φ_{D} is the fourth phase; PE is the fifth phase; GND expresses grounding.

While the conversion control unit controls the first conversion regulation circuit, the intermediate circuit, and the second conversion regulation circuit to be in a boost conversion mode according to the control signal, the variation of the phase of the first regulation voltage and the second regulation voltage may be expressed by

$$\\ {φ}_{A} \to {φ}_{D} \to {φ}_{A} \to {φ}_{D}$$

While the control circuit controls the first conversion regulation circuit, the intermediate circuit, and the second conversion regulation circuit to be in a fast boost conversion mode according to the control signal, the variation of the phase of the first regulation voltage and the second regulation voltage may be expressed by

$$\\ {φ}_{E} \to {φ}_{D} \to {φ}_{E} \to {φ}_{D}$$

While the control circuit controls the first conversion regulation circuit, the intermediate circuit, and the second conversion regulation circuit to be in a boost-buck conversion mode according to the control signal, the variation of the phase of the first regulation voltage and the second regulation voltage may be expressed by

$$\\ {φ}_{A} \to {φ}_{B} \to {φ}_{A} \to {φ}_{D}$$

While the control circuit controls the first conversion regulation circuit, the intermediate circuit, and the second conversion regulation circuit to be in a buck conversion mode according to the control signal, the variation of the phase of the first regulation voltage and the second regulation voltage may be expressed by

$$\\ {φ}_{A} \to {φ}_{B} \to {φ}_{A} \to {φ}_{B}$$

While the control circuit controls the first conversion regulation circuit, the intermediate circuit, and the second conversion regulation circuit to be in a fast buck conversion mode according to the control signal, the variation of the phase of the first regulation voltage and the second regulation voltage may be expressed by

$$\\ {φ}_{C} \to {φ}_{B} \to {φ}_{C} \to {φ}_{B}$$

The intermediate circuit is an inductor. The maximum boost conversion ratio and the maximum buck conversion ratio may be respectively expressed by equations:

$$\\ {CR}_{2 - x boost} = \frac{\frac{2}{3} {V}_{IN}}{H} \times D + \frac{\frac{2}{3} {V}_{IN} - \frac{1}{3} {V}_{OUT}}{H} \times ( 1 - D ) = 0$$

$$\\ {CR}_{2 - x buck} = \frac{\frac{1}{3} {V}_{IN} - \frac{2}{3} {V}_{OUT}}{H} \times D + \frac{- \frac{2}{3} {V}_{OUT}}{H} \times ( 1 - D ) = 0$$

wherein H is the inductance of the inductor.

The conversion control unit includes a ramp control circuit and a switching control circuit. The ramp control circuit is connected to the feedback unit and receives the input reference signal, the feedback signal, a first clock signal, and a second clock signal. The first clock signal is opposite to the second clock. According to the input reference signal, the first clock signal, and the second clock signal, the ramp control circuit generates a boost ramp signal and a buck ramp signal. In the same cycle, the peak and the trough of the waveform of the boost ramp signal are opposite to the peak and the trough of the waveform of the buck ramp signal. The switching control circuit is connected with the symmetric hybrid unit and the ramp control circuit. The switching control circuit receives the feedback signal, a buck comparison signal, a boost comparison signal, a current-mode signal, and a status confirmation signal.

While the symmetric hybrid unit is in a buck conversion mode and the switching control circuit detects that the feedback signal reaches the peak value of the buck ramp signal, the switching control circuit switches the symmetric hybrid circuit to be in a boost-buck conversion mode. Next, while the switching control circuit detects that the feedback signal exceeds the peak value of the buck ramp signal in two successive cycles, the switching control circuit switches the symmetric hybrid circuit to be in a boost conversion mode.

While the symmetric hybrid unit is in a boost conversion mode and the switching control circuit detects that the feedback signal reaches the trough value of the boost ramp signal, the switching control circuit switches the symmetric hybrid circuit to be in a boost-buck conversion mode. Next, while the switching control circuit detects that the feedback signal is below the trough value of the boost ramp signal in two successive cycles, the switching control circuit switches the symmetric hybrid circuit to be in a buck conversion mode.

The ramp control circuit includes a ramp generation circuit, a ramp comparison circuit, and a ramp control output circuit. The ramp comparison circuit is disposed between and connected to the ramp generation circuit and the ramp control output circuit. According to the input reference signal, the first clock signal, and the second clock signal, the ramp generation circuit generates the boost ramp signal and the buck ramp signal.

The ramp comparison circuit compares the boost ramp signal and the feedback signal to generate a boost comparison signal. The ramp comparison circuit compares the buck ramp signal and the feedback signal to generate a buck comparison signal. According to the boost comparison signal and the buck comparison signal, the ramp control output circuit generates the current-mode signal. The current-mode signal indicates whether the symmetric hybrid unit is in a boost conversion mode, buck conversion mode, or a boost-buck conversion mode.

According to the boost comparison signal and the buck comparison signal, the ramp control output circuit generates a boost ramp regulation signal and a buck ramp regulation signal.

The ramp control output circuit transmits the boost ramp regulation signal and the buck ramp regulation signal to the ramp generation circuit.

In the same cycle, the variations of the ramps, peak values, and trough values of the boost ramp signal and the buck ramp signal generated by the ramp generation circuit include three modes:
a normal mode: the trough value of the boost ramp signal is equal to the input reference signal; the peak value of the buck ramp signal is equal to the input reference signal;
a gentle mode: the trough value of the boost ramp signal is greater than the input reference signal; the peak value of the buck ramp signal is smaller than the input reference signal; and
a steep mode: the trough value of the boost ramp signal is smaller than the input reference signal; the peak value of the buck ramp signal is greater than the input reference signal,
   wherein the ramps of the boost ramp signal and the buck ramp signal in the gentle mode are smaller than the ramps of the boost ramp signal and the buck ramp signal in the normal mode; the ramps of the boost ramp signal and the buck ramp signal in the steep mode are greater than the ramps of the boost ramp signal and the buck ramp signal in the normal mode.

While the switching control circuit indicates in the current-mode signal that the symmetric hybrid unit is in the boost conversion mode or the buck conversion mode, the switching control circuit controls the ramp generator circuit to induce the boost ramp signal is in the gentle mode, and the buck ramp signal is in the normal mode, in each cycle. While the switching control circuit indicates in the current-mode signal that the symmetric hybrid unit turns from the boost conversion mode to the boost-buck conversion mode or turns from the buck conversion mode to the boost-buck conversion mode, the switching control circuit controls the ramp generator circuit to induce one of each two cycles has a combination of the boost ramp signal in the gentle mode and the buck ramp signal in the steep mode, another one of each two cycles has a combination of the boost ramp signal in the steep mode and the buck ramp signal in the gentle mode. While the switching control circuit indicates in the current-mode signal that the symmetric hybrid unit is in the buck conversion pattern, the switching control circuit controls the ramp generator circuit to induce the boost ramp signal is in the normal mode, and the buck ramp signal is in the gentle mode, in each cycle.

The conversion control unit includes a status confirmation circuit. The status confirmation circuit receives the peak value of the buck ramp signal, the feedback signal, and the trough value of the boost ramp signal. The status confirmation circuit compares the peak value of the buck ramp signal and the feedback signal and compares the trough value of the boost ramp signal and the feedback signal to generate a status confirmation signal. While the potential of the feedback signal is gradually increasing or decreasing, the status confirmation signal does not change its state. In other words, the status confirmation signal maintains at a high level or a low level. While the potential of the feedback signal changes from rising to descending or from descending into rising, the potential of the status confirmation signal turns from a high level to a low level or from a low level to a high level.

While the status confirmation signal changes and the switching control circuit indicates in the current-mode signal that the symmetric hybrid unit is still in the buck conversion mode, the following cases will occur: the switching control circuit controls the ramp generator circuit to induce the boost ramp signal is in the gentle mode in one of each two cycles; the buck ramp signal is in the steep mode in one of each two cycles; the boost ramp signal is in the steep mode, and the buck ramp signal is in the gentle mode in the another one of each two cycles.

The present invention may further comprise a transient state detection unit. The transient state detection unit is connected with the feedback unit and the conversion control unit. According to the feedback signal, the transient state detection unit outputs a transient boost signal or a transient buck signal to the conversion control unit. According to the transient boost signal and the transient buck signal, the conversion control unit controls the symmetric hybrid unit to vary the conversion ratio.

The transient state detection unit receives the feedback signal and generates a delayed feedback signal according to the feedback signal. The transient state detection unit compares the feedback signal with the delayed feedback signal. While the feedback signal is greater than the delayed feedback signal, the transient state detection unit outputs the transient boost signal. While the feedback signal is smaller than the delayed feedback signal, the transient state detection unit outputs the transient buck signal.

The voltage relationships of the first regulation voltage and the second regulation voltage in another four phases are respectively expressed by

$$\\ XBR , {V}_{x 1} = {V}_{IN} , {V}_{x 2} = \frac{2 {V}_{OUT}}{3} ; XOR , {V}_{x 1} = {V}_{IN} , {V}_{x 2} = GND ;$$

$$\\ XBF , {V}_{x 1} = GND , {V}_{x 2} = {V}_{OUT} ; XOF , {V}_{x 1} = \frac{2 {V}_{IN}}{3} , {V}_{x 2} = {V}_{OUT} ;$$

wherein XBR is a first transient buck phase; XOR is a second transient buck phase; XBF is a first transient boost phase; XOF is a second transient boost phase.

In the buck conversion mode or the fast buck conversion mode, while the conversion control unit receives a transient buck signal, the conversion control unit controls the phases of the first regulation voltage and the second regulation voltage to vary according to the following sequence:

$$X B R \to {φ}_{B} \to X B R \to {φ}_{B}$$

In the buck conversion mode, while the conversion control unit receives a transient boost signal, the conversion control unit controls the phases of the first regulation voltage and the second regulation voltage to vary according to the following sequence:

$${φ}_{A} \to X B F \to {φ}_{A} \to X B F$$

In the fast buck conversion mode, while the conversion control unit receives a transient boost signal, the conversion control unit controls the phases of the first regulation voltage and the second regulation voltage to vary according to the following sequence:

$${φϕ}_{C} \to X B F \to {φ}_{C} \to X B F$$

In the boost conversion mode, while the conversion control unit receives a transient buck signal, the conversion control unit controls the phases of the first regulation voltage and the second regulation voltage to vary according to the following sequence:

$${φ}_{A} \to X O R \to {φ}_{A} \to X O R$$

In the fast boost conversion mode, while the conversion control unit receives a transient buck signal, the conversion control unit controls the phases of the first regulation voltage and the second regulation voltage to vary according to the following sequence:

$${φ}_{E} \to X O R \to {φ}_{E} \to X O R$$

In the boost conversion mode or the fast boost conversion mode, while the conversion control unit receives a transient boost signal, the conversion control unit controls the phases of the first regulation voltage and the second regulation voltage to vary according to the following sequence:

$${φ}_{D} \to X O F \to {φ}_{D} \to X O F$$

The bidirectional hybrid power conversion system further comprises a dead-zone compensation circuit. The dead-zone compensation circuit is disposed between and connected to the conversion control unit and the first conversion regulation circuit. The dead-zone compensation circuit is also disposed between and connected to the conversion control unit and the second conversion regulation circuit. The dead-zone compensation circuit regulates the control signal to control the trigger timings for switching the first conversion regulation circuit and the second conversion regulation circuit to different phases.

In the present invention, the symmetric hybrid unit, the conversion control unit, and the feedback unit cooperate with to realize bidirectional voltage conversions at different conversion ratios, and the conversion ratios can meet USB PD 3.1. Further, the transient state detection unit cooperates with the symmetric hybrid unit, the conversion control unit, and the feedback unit to solve the problem of transient rise or decrease of voltage in the transient state. Furthermore, the conversion control unit and the feedback unit are used to overcome the problems occurring in switching voltage conversion modes.

### BRIEF DESCRIPTION OF THE DRAWINGS

FIG. 1 is a diagram schematically showing a conventional three-level buck-boost converter.

FIG. 2 is a diagram schematically showing a conventional double step-down converter.

FIG. 3 is a diagram schematically showing the architecture of the bidirectional hybrid power conversion system according to one embodiment of the present invention.

FIG. 4 is a diagram schematically showing the circuit of a symmetric hybrid unit according to one embodiment of the present invention.

FIGS. 5A-5B is a diagram schematically showing the circuits of the symmetric hybrid unit in FIG. 4 at different phases while in a fast buck conversion mode.

FIGS. 6A-6B is a diagram schematically showing the circuits of the symmetric hybrid unit in FIG. 4 at different phases while in a buck conversion mode.

FIGS. 7A-7C is a diagram schematically showing the circuits of the symmetric hybrid unit in FIG. 4 at different phases while in a buck-boost conversion mode.

FIGS. 8A-8B is a diagram schematically showing the circuits of the symmetric hybrid unit in FIG. 4 at different phases while in a boost conversion mode.

FIG. 9A-9B is a diagram schematically showing the circuits of the symmetric hybrid unit in FIG. 4 at different phases while in a fast boost conversion mode.

FIG. 10A is a diagram schematically showing a ramp control circuit according to one embodiment of the present invention.

FIG. 10B is a diagram schematically showing a switching control circuit according to one embodiment of the present invention.

FIG. 11 is a diagram schematically showing the waveforms of the boost ramp signals respectively in a normal mode, a gentle mode, and a steep mode according to one embodiment of the present invention.

FIG. 12 is a diagram schematically showing the waveforms of the buck ramp signals respectively in a normal mode, a gentle mode, and a steep mode according to one embodiment of the present invention.

FIG. 13 is a diagram schematically showing a status confirmation circuit according to one embodiment of the present invention.

FIG. 14 is a diagram schematically showing the waveforms of the boost ramp signal, the buck ramp signal, the status confirmation signal, and the current-mode signal, the states of the troughs of the boost ramp signal, and the states of the peaks of the buck ramp signal while the present invention turns from the buck conversion mode to the boost-buck conversion mode and then turns from the boost-buck conversion mode to the boost conversion mode.

FIG. 15 is a diagram schematically showing the waveforms of the boost ramp signal, the buck ramp signal, the status confirmation signal, and the current-mode signal, the states of the troughs of the boost ramp signal, and the states of the peaks of the buck ramp signal while the present invention turns from the boost conversion mode to the boost-buck conversion mode and then turns from the boost-buck conversion mode to the buck conversion mode.

FIG. 16 is a diagram schematically showing a transient state detection circuit according to one embodiment of the present invention.

FIG. 17 is a diagram schematically showing the circuit of the symmetric hybrid unit of FIG. 4 in a first transient buck phase according to an embodiment of the present invention.

FIG. 18 is a diagram schematically showing the circuit of the symmetric hybrid unit of FIG. 4 in a first transient boost phase according to one embodiment of the present invention.

FIG. 19 is a diagram schematically showing the circuit of the symmetric hybrid unit of FIG. 4 in a second transient boost phase according to one embodiment of the present invention.

FIG. 20 is a diagram schematically showing the circuit of the symmetric hybrid unit of FIG. 4 in a second transient buck phase according to an embodiment of the present invention.

FIG. 21 is a diagram schematically showing the waveforms of the output voltage, the feedback signal, the transient boost signal, the current signal, and the current-mode signal while the load rises abruptly.

FIG. 22 is a diagram schematically showing the waveforms of the output voltage, the feedback signal, the transient boost signal, the current signal, and the current-mode signal while the load drops abruptly.

FIG. 23 is a diagram showing the conversion efficiency of the present invention in the buck conversion mode under different loads.

FIG. 24 is a diagram showing the conversion efficiency of the present invention in the boost conversion mode under different loads.

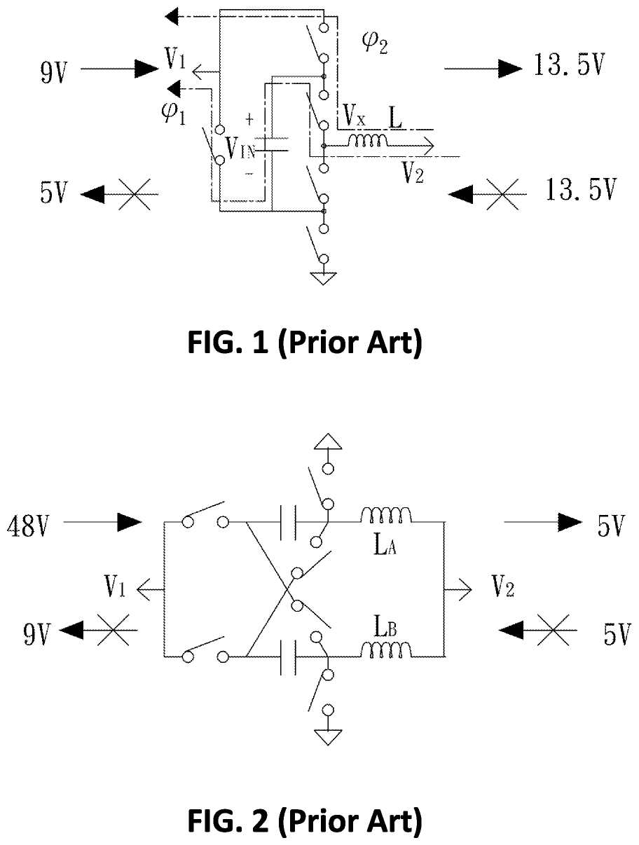

### DETAILED DESCRIPTION OF THE INVENTION

The embodiments of the present invention will be further demonstrated in detail hereinafter in cooperation with the corresponding drawings. In the drawings and the specification, the same numerals represent the same or the like elements as much as possible. For simplicity and convenient labeling, the shapes and thicknesses of the elements may be exaggerated in the drawings. It is easily understood: the elements belonging to the conventional technologies and well known by the persons skilled in the art may be not particularly depicted in the drawings or described in the specification. Various modifications and variations made by the persons skilled in the art according to the contents of the present invention are to be included by in the scope of the present invention.

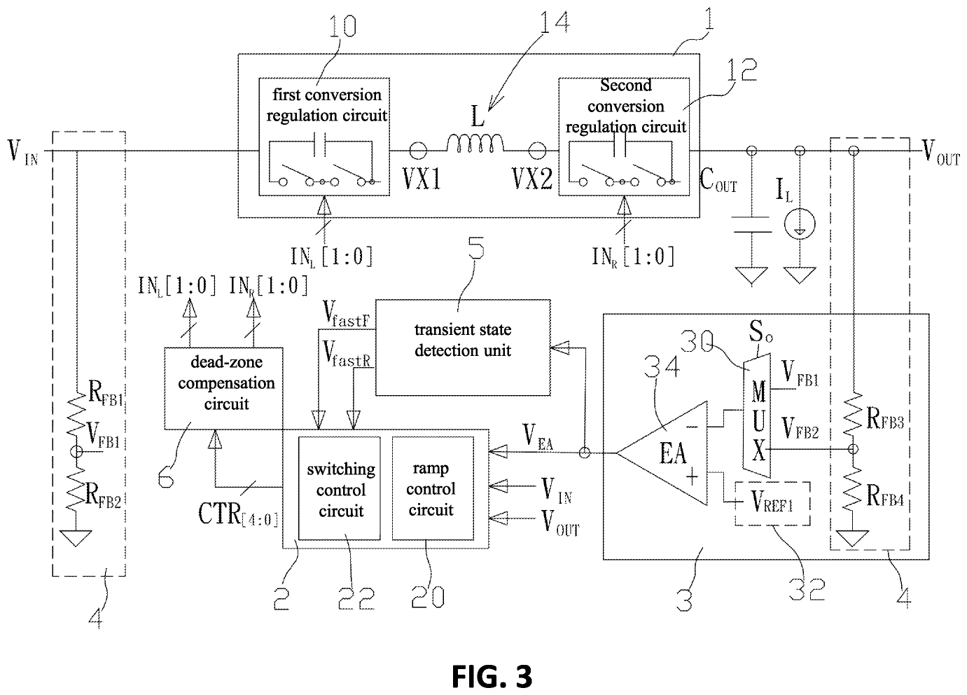

Refer to FIG. 3. The present invention provides a bidirectional hybrid power conversion system, which comprises a symmetric hybrid unit 1, a conversion control unit 2, and a feedback unit 3. The symmetric hybrid unit 1 converts an input voltage V_{IN} into an output voltage V_{OUT} at different conversion ratios selectively. The feedback unit 3 is connected to the symmetric hybrid unit 1 and generates a feedback signal V_{EA} according to the output voltage V_{OUT} and a reference voltage V_{REF1}. The conversion control unit 2 is disposed between and connected with the symmetric hybrid unit 1 and the feedback unit 3. The conversion control unit 2 receives the feedback signal V_{EA}, the input signal V_{IN} and the output signal V_{OUT}. According to the feedback signal V_{EA}, the input signal V_{IN}, and the output signal V_{OUT}, the conversion control unit 2 generates a control signal CTR to control the symmetric hybrid unit 1 to raise or lower the conversion ratio (CR), wherein CR=(V_{OUT}/V_{IN}), whereby to make the symmetric hybrid unit 1 convert the input voltage V_{IN} into the output voltage V_{OUT} stably.

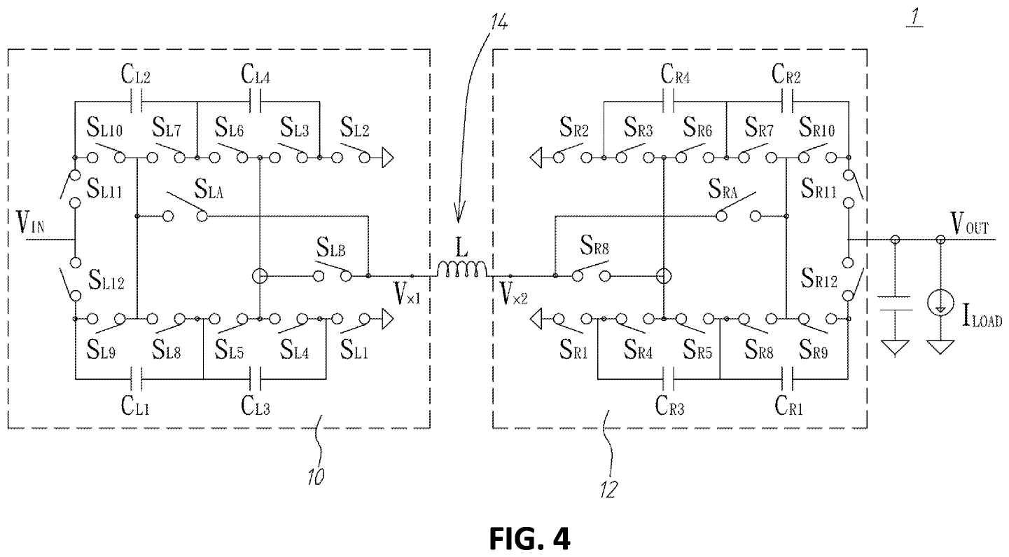

Refer to FIG. 4. In one embodiment, the symmetric hybrid unit 1 includes a first conversion regulation circuit 10, a second conversion regulation circuit 12, and an intermediate circuit 14. The intermediate circuit 14 is disposed between the first conversion regulation circuit 10 and the second conversion regulation circuit 12. A maximum boost conversion ratio, which may be achieved by the first conversion regulation circuit 10, the intermediate circuit 14, and the second conversion regulation circuit 12, may be expressed by Equation 1:

$$\frac{{V}_{OUT}}{{V}_{IN}} = C {R}_{2 - x boost} = \frac{2}{1 - D} \qquad ( Equation 1 )$$

A maximum buck conversion ratio, which may be achieved by the first conversion regulation circuit 10, the intermediate circuit 14, and the second conversion regulation circuit 12, may be expressed by Equation 2:

$$\frac{{V}_{OUT}}{{V}_{IN}} = C {R}_{2 - x buck} = \frac{D}{2} \qquad ( Equation 2 )$$

wherein CR_{2-x boost} is the maximum boost conversion ratio; CR_{2-x buck} is the maximum buck conversion ratio; D is the duty cycle of the first conversion regulation circuit 10 and the second conversion regulation circuit 12. According to the control signal CTR, the conversion control unit 2 controls the conversion ratio of the symmetric hybrid unit 1 to range between the maximum boost conversion ratio and the maximum buck conversion ratio. In details, D is the duty cycle of the switches S_{L1}˜S_{L12}, S_{R1}˜S_{R12}, S_{LA}, S_{LB}, S_{RA}, and S_{RB} of the first conversion regulation circuit 10 and the second conversion regulation circuit 12. In FIG. 4, C_{L1}˜C_{L4} and C_{R1}˜C_{R4} are capacitors.

Refer to FIG. 3 again. In this embodiment, the feedback unit 3 includes a multiplexer 30, a reference voltage generation circuit 32, and a feedback comparator 34. The multiplexer 30 is connected to the first conversion regulation circuit 10 and the second conversion regulation circuit 12. While the first conversion regulation circuit 10 functions as the output side, the multiplexer 30 receives the voltage output by the first conversion regulation circuit 10. While the second conversion regulation circuit 12 functions as the output side, the multiplexer 30 receives the voltage output by the second conversion regulation circuit 12. The reference voltage generation circuit 32 generates a reference voltage. The comparator 34 is connected to the multiplexer 30 and the reference voltage generation circuit 32, receiving the reference voltage and the output voltage, and comparing the reference voltage and the output voltage to output a feedback signal.

In this embodiment, two voltage detection circuits 4 are respectively disposed between the symmetric hybrid unit 1 and an input voltage terminal and disposed between the symmetric hybrid unit 1 and an output voltage terminal, used to detect the input signal V_{IN}, and the output signal V_{OUT}. The present invention provides a bidirectional hybrid power conversion system. While the current flows from left to right in FIG. 3, the first conversion regulation circuit 10 functions as the input side, and the second conversion regulation circuit 12 functions as the output side. In such a case, the left node of the symmetric hybrid unit 1 is the input voltage terminal, and the voltage detection circuit 4 at the left side of the symmetric hybrid unit 1 detects the input voltage V_{FB1}; the right node of the symmetric hybrid unit 1 is the output voltage terminal, and the voltage detection circuit 4 at the right side of the symmetric hybrid unit 1 detects the output voltage V_{FB2}. While the current flows from right to left in FIG. 3, the second conversion regulation circuit 12 functions as the input side, and the first conversion regulation circuit 10 functions as the output side. In such a case, the right node of the symmetric hybrid unit 1 is the input voltage terminal, and the voltage detection circuit 4 at the right side of the symmetric hybrid unit 1 detects the input voltage V_{FB1}; the left node of the symmetric hybrid unit 1 is the output voltage terminal, and the voltage detection circuit 4 at the left side of the symmetric hybrid unit 1 detects the output voltage V_{FB2}.

In this embodiment, a first regulation voltage Vₓ₁ exists between the intermediate circuit 14 and the first conversion regulation circuit 10. A second regulation voltage Vₓ₂ exists between the intermediate circuit 14 and the second conversion regulation circuit 12. The voltage relationships of the first regulation voltage Vₓ₁ and the second regulation voltage Vₓ₂ in five different phases are respectively expressed by

$${φ}_{A} : {V}_{x 1} = \frac{2 {V}_{IN}}{3} , {V}_{x 2} = \frac{2 {V}_{OUT}}{3} ;$$

$${φ}_{B} : {V}_{x 1} = G N D , {V}_{x 2} = \frac{2 {V}_{OUT}}{3} ;$$

$${φ}_{C} : {V}_{x 1} = \frac{{V}_{IN}}{3} , {V}_{x 2} = \frac{2 {V}_{OUT}}{3} ;$$

$${φ}_{D} : {V}_{x 1} = \frac{2 {V}_{IN}}{3} , {V}_{x 2} = G N D ;$$

$$and$$

$${φ}_{E} : {V}_{x 1} = \frac{2 {V}_{IN}}{3} , {V}_{x 2} = \frac{{V}_{OUT}}{3}$$

wherein Vₓ₁ is the first regulation voltage; Vₓ₂ is the second regulation voltage; φ_{A} is the first phase; φ_{B} is the second phase; φ_{C} is the third phase; φ_{D} is the fourth phase; φ_{E} is the fifth phase; GND expresses grounding.

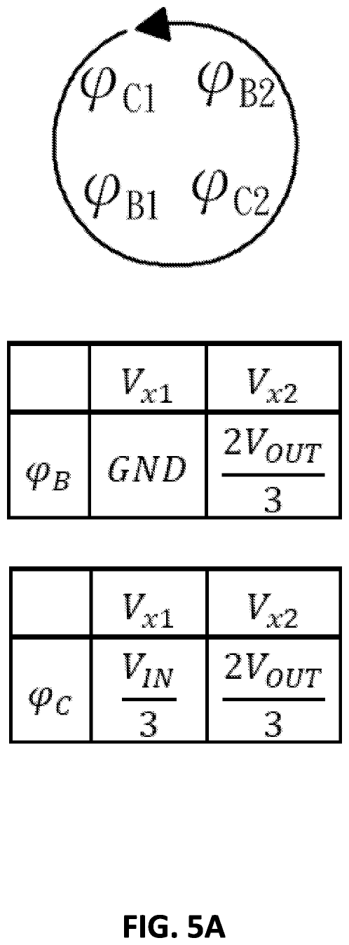

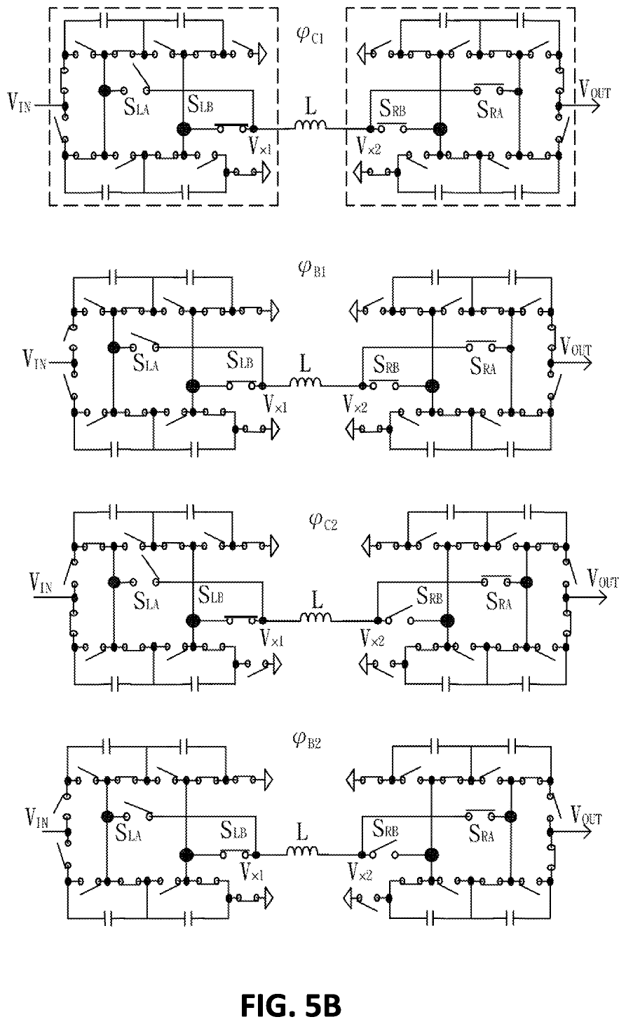

In some embodiments of the present invention, the fast buck conversion mode is N times the buck conversion mode. The N is a positive real number greater than 1, or a natural number greater than 1. In some embodiments, the N is equal to 2. Thus, the fast buck conversion mode is two times the buck conversion mode and is expressed as 2-X buck mode, wherein X is the multiplication, and buck mode is short for buck conversion mode. Refer to FIGS. 5A-5B. In this embodiment, while the conversion control unit 2 controls the first conversion regulation circuit 10, the intermediate circuit 14, and the second conversion regulation circuit 12 to be in a fast buck conversion mode according to the control signal CTR, the variation of the phase of the first regulation voltage Vₓ₁ and the second regulation voltage Vₓ₂ may be expressed by

$${φ}_{C 1} \to {φ}_{B 1} \to {φ}_{C 2} \to {φ}_{B 2}$$

In the φ_{C1} and φ_{C2} circuit structures of FIG. 5A-5B, the switches are respectively in a turn-on state and a turn-off. The first regulation voltage Vₓ₁ and the second regulation voltage Vₓ₂ generated by the φ_{C1} and φ_{C2} circuit structures are equivalent to that generated by the Pc circuit. In the φ_{B1} and φ_{B2} circuit structures of FIG. 5A-5B, the switches are respectively in a turn-on state and a turn-off. The φ_{B1} and φ_{B2} circuit structures are equivalent to the PB circuit structure.

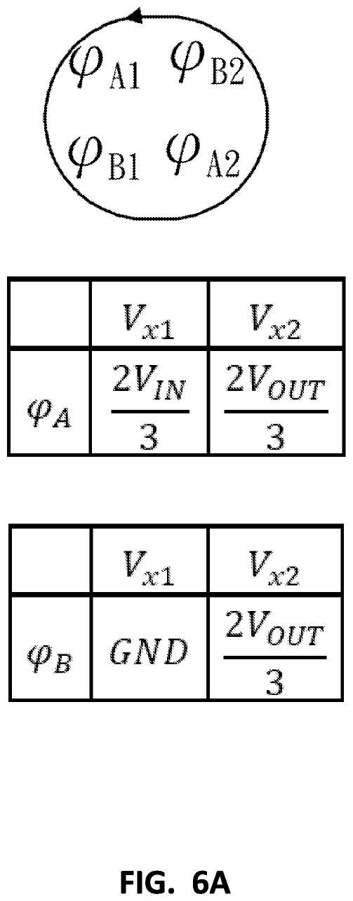

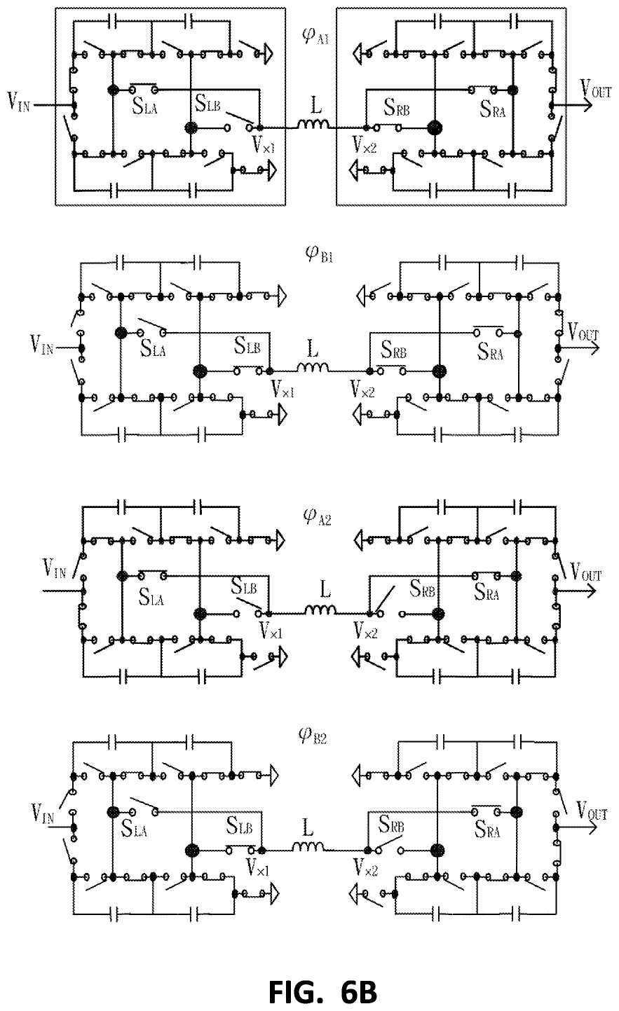

Refer to FIGS. 6A-6B. While the conversion control unit 2 controls the first conversion regulation circuit 10, the intermediate circuit 14, and the second conversion regulation circuit 12 to be in buck conversion mode according to the control signal CTR, the variation of the phase of the first regulation voltage Vₓ₁ and the second regulation voltage Vₓ₂ may be expressed by

$${φ}_{A 1} \to {φ}_{B 1} \to {φ}_{A 2} \to {φ}_{B 2}$$

In the φ_{A1} and φ_{A2} circuit structures of FIG. 6A-6B, the switches are respectively in a turn-on state and a turn-off. The first regulation voltage Vₓ₁ and the second regulation voltage Vₓ₂ generated by the φ_{C1} and φ_{C2} circuit structures are equivalent to that generated by the φ_{A} circuit. The φ_{B1} and φ_{B2} circuit structures are equivalent to the φDB circuit structure.

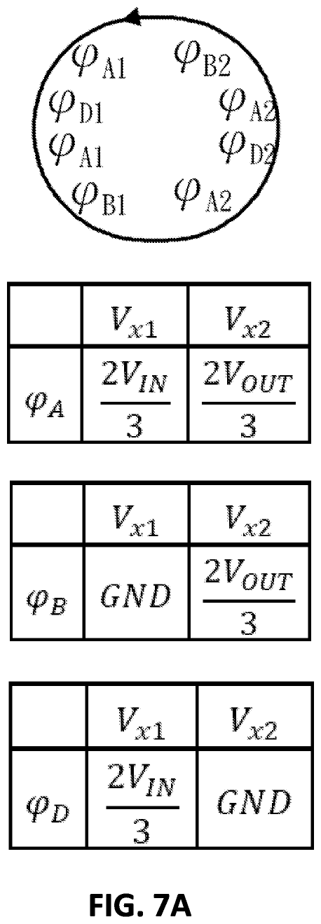

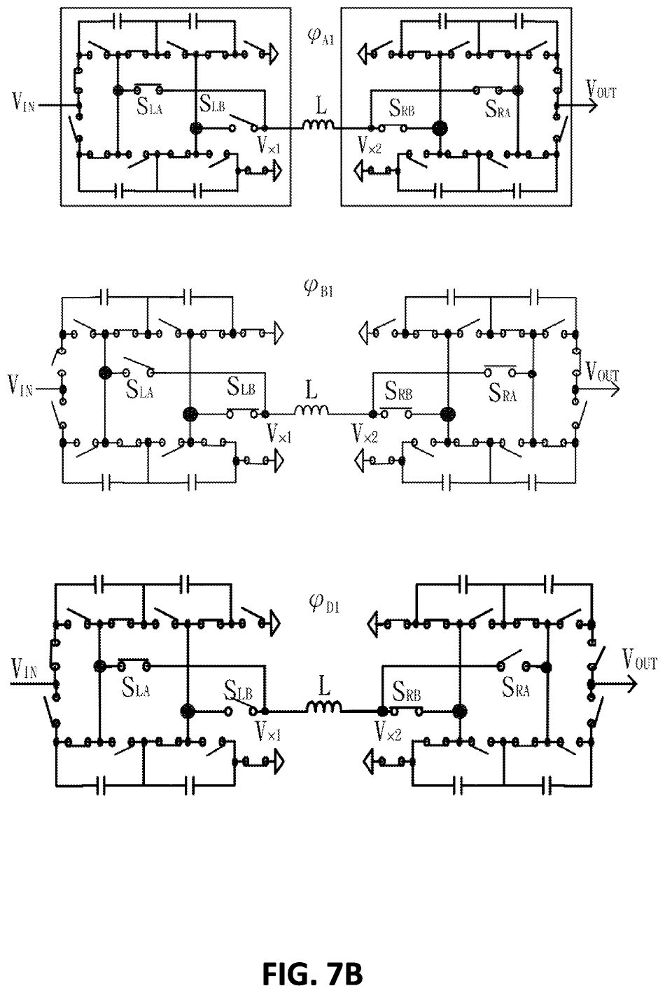

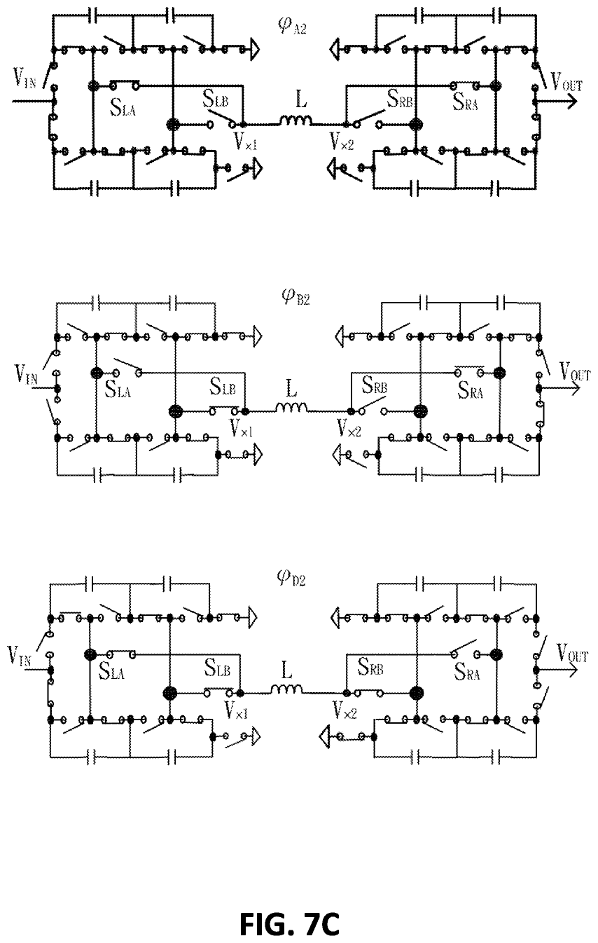

Refer to FIGS. 7A-7C. While the conversion control unit 2 controls the first conversion regulation circuit 10, the intermediate circuit 14, and the second conversion regulation circuit 12 to be in a buck-boost conversion mode according to the control signal CTR, the variation of the phase of the first regulation voltage Vₓ₁ and the second regulation voltage Vₓ₂ may be expressed by

$${φ}_{A 1} \to {φ}_{B 1} \to {φ}_{A 2} \to {φ}_{D 2} \to {φ}_{A 2} \to {φ}_{B 2} \to {φ}_{A 1} \to {φ}_{D 1}$$

In the φ_{D1} and φ_{D2} circuit structures of FIG. 6A-6B, the switches are respectively in a turn-on state and a turn-off. The first regulation voltage Vₓ₁ and the second regulation voltage Vₓ₂ generated by the φ_{C1} and φ_{C2} circuit structures are equivalent to that generated by the op circuit. The φ_{B1} and φ_{B2} circuit structures are equivalent to the OB circuit structure.

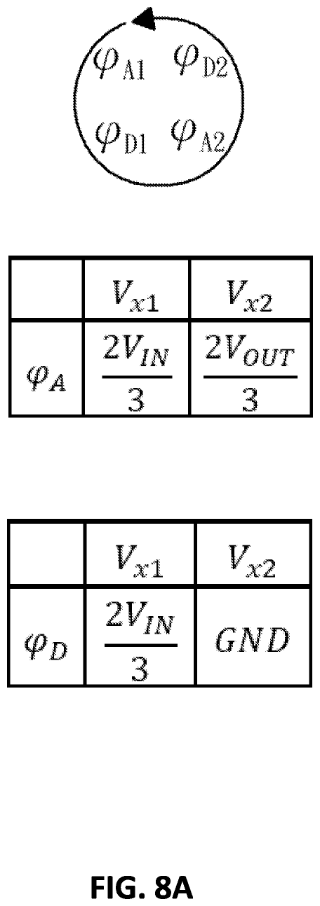

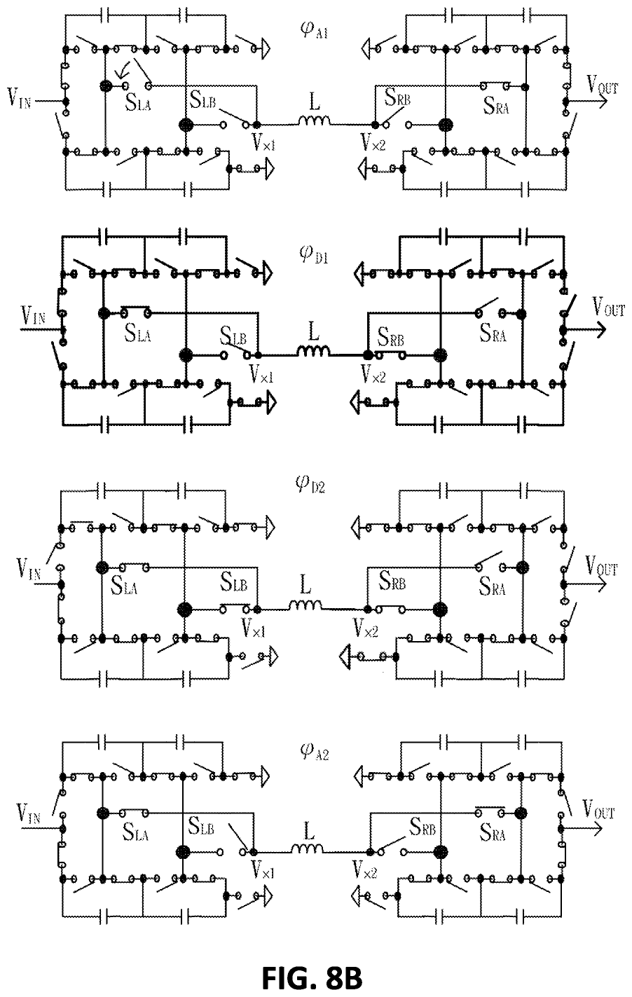

Refer to FIGS. 8A-8B. While the conversion control unit 2 controls the first conversion regulation circuit 10, the intermediate circuit 14, and the second conversion regulation circuit 12 to be in a boost conversion mode according to the control signal CTR, the variation of the phase of the first regulation voltage Vₓ₁ and the second regulation voltage Vₓ₂ may be expressed by

$${φ}_{A 1} \to {φ}_{D 1} \to {φ}_{A 2} \to {φ}_{D 2}$$

In FIG. 8A-8B, the φ_{A1} and φ_{A2} circuit structures are equivalent to the φ_{A} circuit structure; the φ_{D1} and φ_{D2} circuit structures are equivalent to the φ_{D} circuit structure.

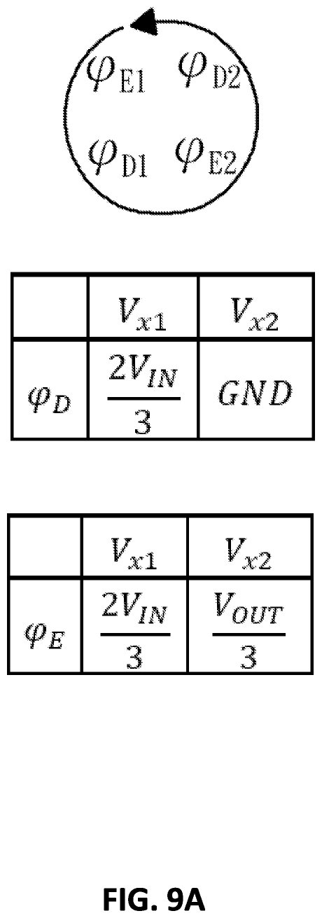

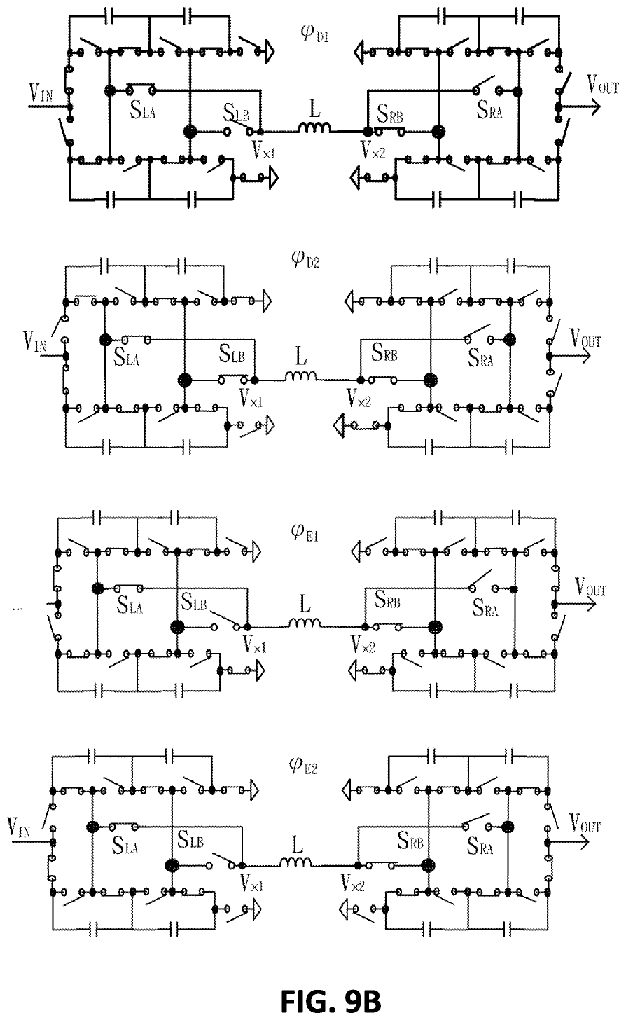

In some embodiments of the present invention, the fast boost conversion mode is N times the boost conversion mode. The N is a positive real number greater than 1 or a natural number greater than 1. In some embodiments, the N is equal to 2. Thus, the fast boost conversion mode is two times the boost conversion mode and is expressed as 2-X boost mode, wherein X is the multiplication and boost mode is short for boost conversion mode. Refer to FIGS. 9A-9B. While the conversion control unit 2 controls the first conversion regulation circuit 10, the intermediate circuit 14, and the second conversion regulation circuit 12 to be in the fast boost conversion mode according to the control signal CTR, the variation of the phase of the first regulation voltage Vₓ₁ and the second regulation voltage Vₓ₂ may be expressed by

$${φ}_{E 1} \to {φ}_{D 1} \to {φ}_{E 2} \to {φ}_{D 2}$$

In the φ_{E1} and φ_{E2} circuit structures of FIG. 9A-9B, the switches are respectively in a turn-on state and a turn-off. The first regulation voltage Vₓ₁ and the second regulation voltage Vₓ₂ generated by the φ_{E1} and φ_{E2} circuit structures are equivalent to that generated by the φ_{E} circuit. The φ_{D1} and φ_{D2} circuit structures are equivalent to the φ_{D} circuit structure.

It is learned from the φ_{A1}, φ_{A2}, φ_{B1}, φ_{B2}, φ_{C1}, φ_{C2}, φ_{D1}, φ_{D2}, φ_{E1} and φ_{E2}: the architecture of the first regulation voltage Vₓ₁ is symmetric to the architecture of the second regulation voltage Vₓ₂; different configurations of the turn-on state and the turn-off state of the switches may generate identical or different phases. Any circuit architecture, which can make the phase variations of the first regulation voltage Vₓ₁ and the second regulation voltage Vₓ₂ be φ_{A}(φ_{A1}, φ_{A2}), φ_{B}(φ_{B1}, φ_{B2}), φ_{C}(φ_{C1}, φ_{C2}), φ_{D}(φ_{D1}, φ_{D2}) and φ_{E}(φ_{E1}, φ_{E2}) is to be included by the scope of the present invention.

Refer to FIG. 3. In this embodiment, the intermediate circuit is an inductor L. The maximum boost conversion ratio and the maximum buck conversion ratio may be respectively expressed Equation 3 and Equation 4:

$$C {R}_{2 - x boost} = \frac{\frac{2}{3} {V}_{IN}}{H} \times D + \frac{\frac{2}{3} {V}_{IN} - \frac{1}{3} {V}_{OUT}}{H} \times ( 1 - D ) = 0 \qquad ( Equation 3 )$$

$$C {R}_{2 - x buck} = \frac{\frac{1}{3} {V}_{IN} - \frac{2}{3} {V}_{OUT}}{H} \times D + \frac{- \frac{2}{3} {V}_{OUT}}{H} \times ( 1 - D ) = 0 \qquad ( Equation 4 )$$

wherein H is the inductance of the inductor.

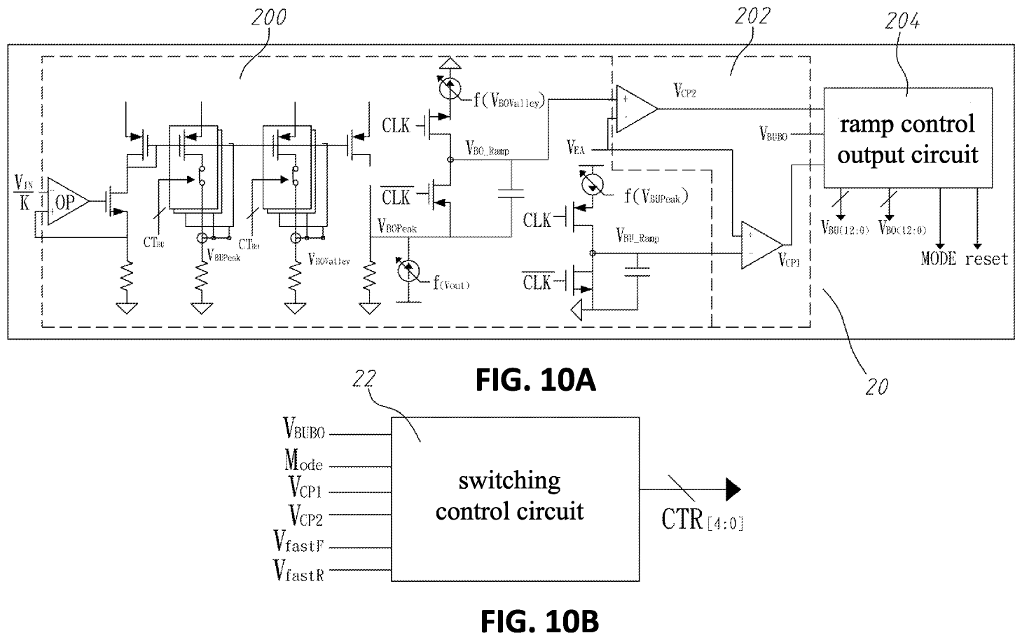

Refer to FIG. 3, FIG. 10A, and FIG. 10B. In this embodiment, the control unit 2 includes a ramp control circuit 20 and a switching control circuit 22. The ramp control circuit 20 is connected to the feedback unit 3. The switching control circuit 22 is connected to the symmetric hybrid unit 1 and the ramp control circuit 20. The switching control circuit 22 receives the feedback signal V_{EA}, a buck comparison signal V_{CP2}, a boost comparison signal V_{CP1}, a current-mode signal MODE, and a state confirmation signal V_{BUBO}.

The ramp control circuit 20 receives the reference signal, the feedback signal, a first clock signal, and a second clock signal. The first clock signal is opposite to the second clock.

The ramp control circuit 20 receives an input reference signal

$$\frac{{V}_{IN}}{K} ,$$

a first clock signal CLK, and a second clock signal C̅L̅K̅ and generates a boost ramp signal V_{BO_Ramp} and a buck ramp signal V_{BU_Ramp}. The first clock signal CLK is opposite to the second clock CLK.

The ramp control circuit 20 includes a ramp generation circuit 200, a ramp comparison circuit 202, and a ramp control output circuit 204. The ramp comparison circuit 202 is disposed between and connected with the ramp generation circuit 200 and the ramp control output circuit 204. According to the input reference signal

$$\frac{{V}_{IN}}{K} ,$$

the first clock signal CLK, and the second clock signal C̅L̅K̅, the ramp generation circuit 200 generates the boost ramp signal V_{BO_Ramp} and a buck ramp signal V_{BU_Ramp}. In the same cycle, the peak and the trough of the waveform of the boost ramp signal V_{BO_Ramp} are opposite to the peak and the trough of the waveform of the buck ramp signal V_{BU_Ramp}. The input reference signal

$$\frac{{V}_{IN}}{K}$$

is equal to the input voltage V_{IN} divided by a constant K, wherein K is normally greater than 1. For example, V_{IN} is 5V, and K is 10; thus, the input reference signal

$$\frac{{V}_{IN}}{K}$$

is a smaller potential signal (0.5V). Alternatively, the input reference signal

$$\frac{{V}_{IN}}{K}$$

may be equal to V_{IN}−K. For example, V_{IN} is 5V, and K is 4.5V. Therefore, V_{IN}−K may be used as the input reference signal. However,

$$\frac{{V}_{IN}}{K}$$

is simpler in circuit design. Therefore, the present invention adopts

$$\frac{{V}_{IN}}{K}$$

as the input reference signal. However, the present invention does not exclude using V_{IN}−K as the input reference signal.

While the symmetric hybrid unit 1 is in the buck conversion mode and the switching control circuit 22 detects that the feedback signal V_{EA} reaches the peak value of the buck ramp signal V_{BU_Ramp}, the switching control circuit 22 switches the symmetric hybrid unit 1 to be in the boost-buck conversion mode. Next, if the switching control circuit 22 detects that the feedback signal V_{EA} exceeds the peak value of the buck ramp signal V_{BU_Ramp} in two successive cycles, the switching control circuit 22 switches the symmetric hybrid unit 1 into the boost conversion mode.

While the symmetric hybrid unit 1 is in the boost conversion mode and the switching control circuit 22 detects that the feedback signal V_{EA} reaches the trough value of the boost ramp signal V_{BO_Ramp}, the switching control circuit 22 switches the symmetric hybrid unit 1 to be in the boost-buck conversion mode. Next, if the switching control circuit 22 detects that the feedback signal V_{EA} is lower than the peak value of the boost ramp signal V_{BO_Ramp} in two successive cycles, the switching control circuit 22 switches the symmetric hybrid unit 1 into the buck conversion mode.

Refer to FIG. 10A. In this embodiment, the ramp comparison circuit 202 compares the boost ramp signal V_{BO_Ramp} and the feedback signal V_{EA} to generate a boost comparison signal V_{CP2}. In FIG. 10A, the comparator is used to compare the boost ramp signal V_{BO_Ramp} and the feedback signal V_{EA}. The ramp comparison circuit 202 compares the buck ramp signal V_{BU_Ramp} and the feedback signal V_{EA} to generate a buck comparison signal V_{CP1}. In FIG. 10A, the boost ramp signal V_{BO_Ramp} and the feedback signal V_{EA} are compared by the comparator. According to the boost comparison signal V_{CP2} and the buck comparison signal V_{CP1}, the ramp control output circuit 204 generates the current-mode signal MODE. The current-mode signal MODE indicates whether the symmetric hybrid unit 1 is in the boost conversion mode, the buck conversion mode, or the boost-buck conversion mode.

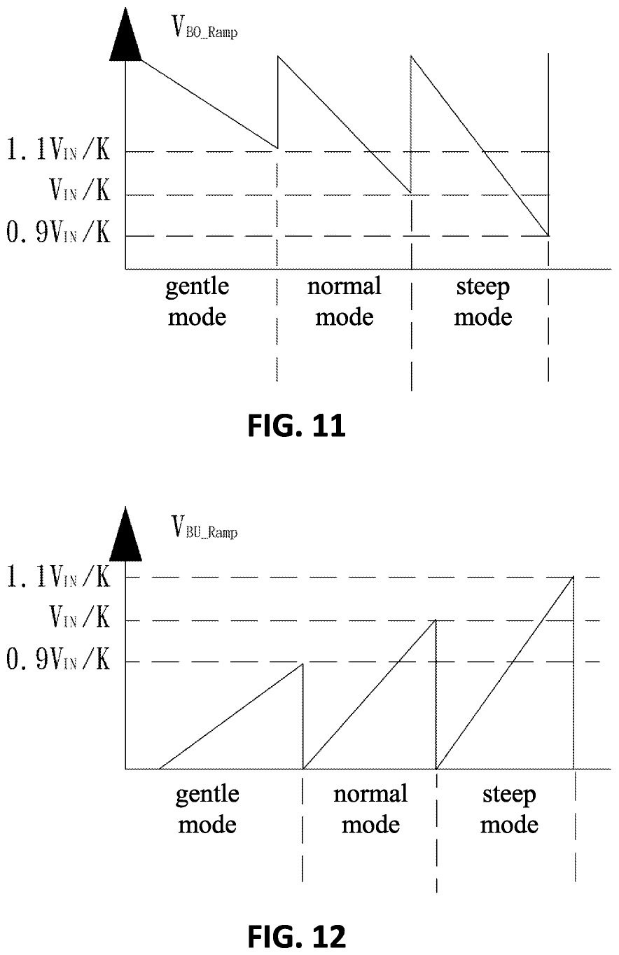

Refer to FIGS. 10-12. According to the boost comparison signal V_{CP2} and the buck comparison signal V_{CP1}, the ramp control output circuit 204 generates, the ramp control output circuit 204 generates a boost ramp regulation signal V_{BO} and a buck ramp regulation signal V_{BU}. The ramp control output circuit 204 transmits the boost ramp regulation signal V_{BO} and the buck ramp regulation signal V_{BU} to the ramp generation circuit 200 (labelled by CT_{BO} and CT_{BU} in FIG. 10A). In the same cycle, the relationships of the ramps, peak values and trough values of the boost ramp signal V_{BO} and the buck ramp signal V_{BU} generated by the ramp generation circuit 200 have three types of variations:

a normal mode: the trough value of the boost ramp signal V_{BO_Ramp} is equal to the input reference signal; the peak value of the buck ramp signal is equal to the input reference signal;
a gentle mode: the trough value of the boost ramp signal V_{BO_Ramp} IS greater than the input reference signal; the peak value of the buck ramp signal V_{BU_Ramp} is smaller than the input reference signal; and
a steep mode: the trough value of the boost ramp signal V_{BO_Ramp} is smaller than the input reference signal; the peak value of the buck ramp signal V_{BU_Ramp} is greater than the input reference signal,
   wherein the ramps of the boost ramp signal and the buck ramp signal in the gentle mode are smaller than the ramps of the boost ramp signal and the buck ramp signal in the normal mode; the ramps of the boost ramp signal and the buck ramp signal in the steep mode are greater than the ramps of the boost ramp signal and the buck ramp signal in the normal mode.

In the gentle mode of this embodiment, the trough value of the boost ramp signal V_{BO_Ramp} is 1.1 times the input reference signal; the peak value of the buck ramp signal V_{BU_Ramp} is 0.9 times the input reference signal. In the steep mode, the trough value of the boost ramp signal V_{BO_Ramp} is 0.9 times the input reference signal; the peak value of the buck ramp signal V_{BU_Ramp} is 1.1 times the input reference signal. However, in some embodiments of the present invention, the trough value of the boost ramp signal V_{BO_Ramp} and the peak value of the buck ramp signal V_{BU_Ramp} may be greater or smaller than the input reference signal by different times in the gentle mode; the trough value of the boost ramp signal V_{BO_Ramp} and the peak value of the buck ramp signal V_{BU_Ramp} may be smaller or greater than the input reference signal by different times in the steep mode.

The ramps of the boost ramp signal V_{BO_Ramp} and the buck ramp signal V_{BU_Ramp} in the gentle mode are smaller than the ramps of the boost ramp signal V_{BO_Ramp} and the buck ramp signal V_{BU_Ramp} in the normal mode; the ramps of the boost ramp signal V_{BO_Ramp} and the buck ramp signal V_{BU_Ramp} in the steep mode are greater than the ramps of the boost ramp signal V_{BO_Ramp} and the buck ramp signal V_{BU_Ramp} in the normal mode.

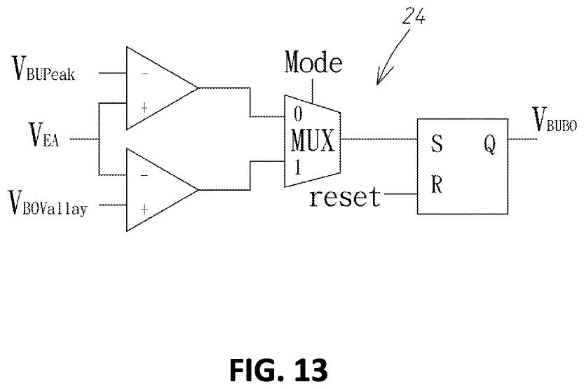

Refer to FIG. 13. The conversion control unit 2 further includes a status confirmation circuit 24. The status confirmation circuit 24 further includes a comparator, a multiplexer, and an inverter, as shown in FIG. 13. The status confirmation circuit 24 receives the peak value V_{BUPeak} of the buck ramp signal, the feedback signal V_{EA}, and the trough value V_{BOValley} of the boost ramp signal. The status confirmation circuit 24 compares the peak value V_{BUPeak} of the buck ramp signal and the feedback signal V_{EA} and compares the trough value V_{BOValley} of the boost ramp signal and the feedback signal V_{EA} to generate a status confirmation signal V_{BUBO}. While the potential of the feedback signal V_{EA} is gradually increasing or decreasing, the status confirmation signal V_{BUBO} does not change its state. In other words, the status confirmation signal V_{BUBO} maintains at a high level or a low level.

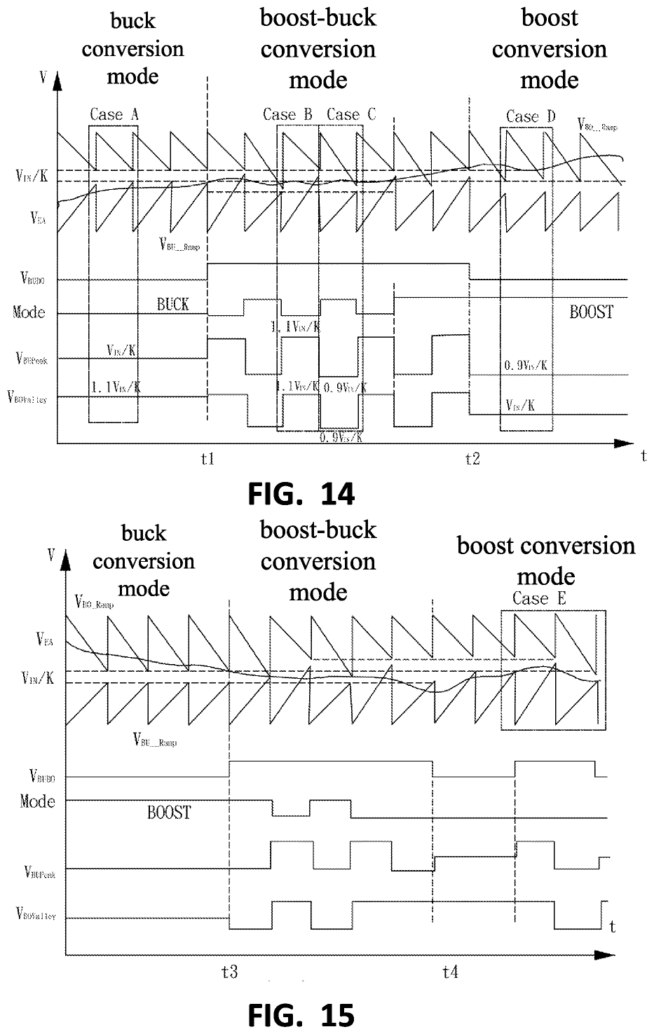

Refer to FIG. 14. While the switching control circuit 22 indicates in the current-mode signal MODE that the symmetric hybrid unit 1 is in the boost (buck) conversion mode and the state of the status confirmation signal does not change, each cycle of the abovementioned period has a sets of the boost ramp signal V_{BO_Ramp} in the gentle mode and the buck ramp signal V_{BU_Ramp} in the normal mode (referred to as Case A thereinafter).

While the switching control circuit 22 indicates in the current-mode signal MODE that the symmetric hybrid unit 1 is in the boost (buck) period of the boost-buck conversion mode and the state of the status confirmation signal changes, one of each two cycles of the abovementioned period has a sets of the boost ramp signal V_{BO_Ramp} in the gentle mode and the buck ramp signal V_{BU_Ramp} in the steep mode (referred to as Case B thereinafter), and another one of each two cycles has a combination of the boost ramp signal V_{BO_Ramp} in the steep mode and the buck ramp signal V_{BU_Ramp} in the gentle mode (referred to as Case C thereinafter).

While the switching control circuit 22 indicates in the current-mode signal MODE that the symmetric hybrid unit 1 is in the boost period of the boost-buck conversion mode and the state of the status confirmation signal changes, each cycle of the abovementioned period has a sets of the boost ramp signal V_{BO_Ramp} in the normal mode and the buck ramp signal V_{BU_Ramp} in the gentle mode (referred to as Case D thereinafter).

Refer to FIG. 15. While the switching control circuit 22 indicates in the current-mode signal MODE that the symmetric hybrid unit 1 is in the boost conversion mode or in the buck conversion mode and the state of the status confirmation signal changes, one of each two cycles of the abovementioned period has a sets of the boost ramp signal V_{BO_Ramp} in the gentle mode and the buck ramp signal V_{BU_Ramp} in the steep mode and another one of each two cycles has a combination of the boost ramp signal V_{BO_Ramp} in the steep mode and the buck ramp signal V_{BU_Ramp} in the gentle mode (referred to as Case E thereinafter). Meanwhile, if neither the feedback signal V_{EA} exceeds the peak value of the buck ramp signal V_{BU_Ramp} in two successive cycles nor the feedback signal V_{EA} is lower than the trough value of the boost ramp signal V_{BO_Ramp} in two successive cycles, the switching control circuit 22 will not switch the symmetric hybrid unit 1 from the boost conversion mode into the boost conversion mode, or the switching control circuit 22 will not switch the symmetric hybrid unit 1 from the buck conversion mode into the boost conversion mode.

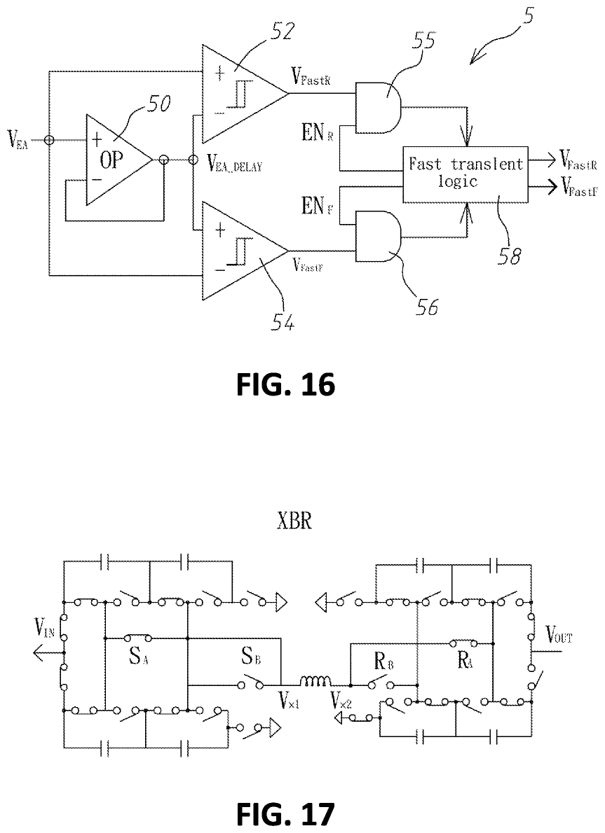

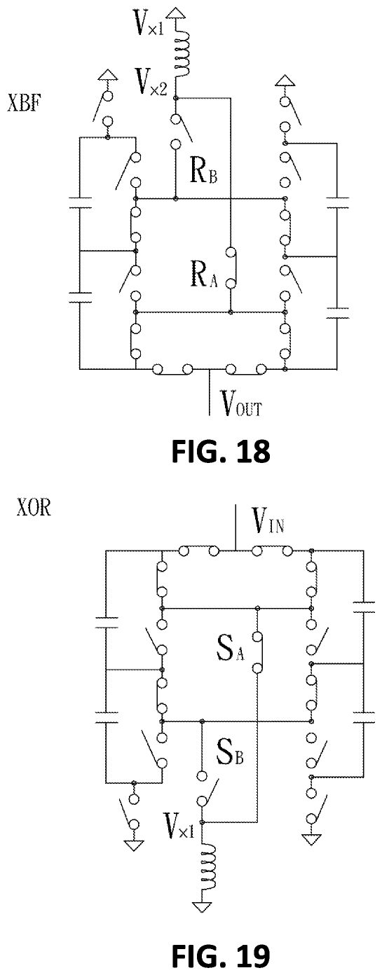

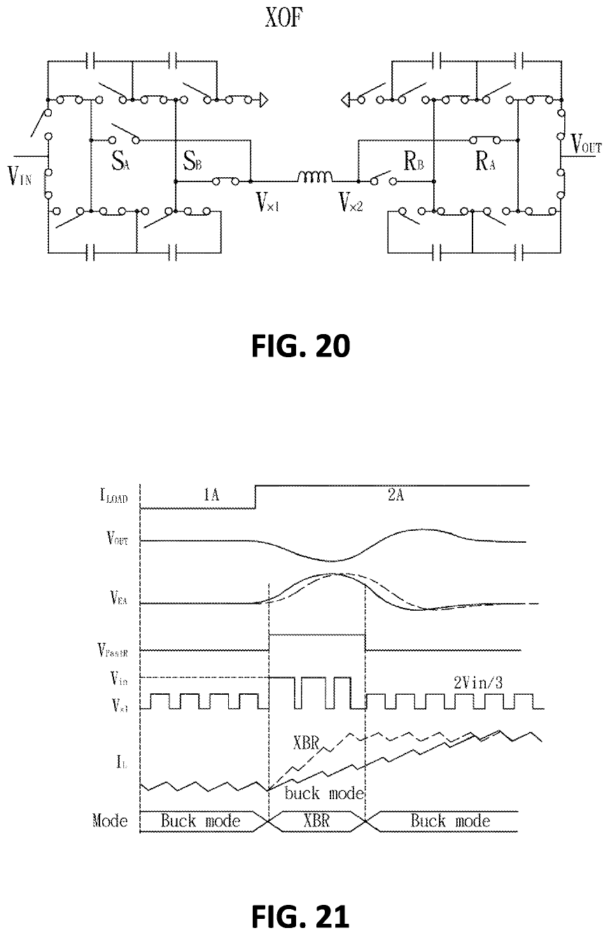

Refer to FIG. 3 and FIG. 16. The bidirectional hybrid power conversion system of the present invention may further comprise a transient state detection unit 5. The transient state detection unit 5 is connected with the feedback unit 3 and the conversion control unit 2. According to the feedback signal V_{EA}, the transient state detection unit 5 outputs a transient boost signal V_{FastR} or an transient buck signal to the conversion control unit 2. According to the transient boost signal V_{FastR} and the transient buck signal V_{FastF}, the conversion control unit 2 controls the symmetric hybrid unit 1 to vary the conversion ratio.

Refer to FIG. 16. The transient state detection unit 5 includes a first comparator 50, a second comparator 52, a third comparator 54, a first AND logic grate 55, a second AND logic grate 56, and a fast-conversion logic unit 58. The first comparator 50 receives the feedback signal V_{EA} and the output value of the first comparator 50. According to the feedback signal V_{EA} and the output value of the first comparator 50, the first comparator 50 generates a delay feedback signal V_{EA_DELAY}. The output value of the first comparator 50 is equal to the delay feedback signal V_{EA_DELAY}. In other words, the first comparator 50 is to compare the feedback signal V_{EA} and the delay feedback signal V_{EA_DELAY}. While the second comparator 52 together with the first AND logic gate 55 and the fast-conversion logic unit 58 determines that the feedback signal V_{EA} is greater than the delay feedback signal V_{EA_DELAY}, the second comparator 52 outputs the transient boost signal V_{FastR}. While the third comparator 54 together with the second AND logic grate 56 and the fast-conversion logic unit 58 determines that the feedback signal V_{EA} is smaller than the delay feedback signal V_{EA_DELAY}, the third comparator 54 outputs the transient buck signal V_{FastF}.

One input terminal of the first AND logic gate 55 receives the transient boost comparison signal V_{FastR}_output by the second comparator 52; another input terminal of the first AND logic gate 55 receives a first enable signal EN_{R}. As long as the first AND logic gate 55 receives the first enable signal EN_{R}, the first AND logic gate 55 outputs the transient boost comparison signal V_{FastR} to the fast-conversion logic unit 58. Similarly, one input terminal of the second AND logic gate 56 receives the transient buck comparison signal V_{FastF} output by the third comparator 54; another input terminal of the second AND logic gate 56 receives a second enable signal EN_{F}. As long as the second AND logic gate 56 receives the second enable signal EN_{F}, the second AND logic gate 56 outputs the transient boost comparison signal V_{FastR} to the fast-conversion logic unit 58.

Besides, the fast-conversion logic unit 58 receives an external enable-trigger signal to output the first enable signal EN_{R} and the second enable signal EN_{F}, whereby the fast-conversion logic unit 58 can receive the signal output by the first AND logic gate 55 and process the signal into the transient boost signal V_{FastR}, and whereby the fast-conversion logic unit 58 can receive the signal output by the second AND logic gate 56 and process the signal into the transient buck signal V_{FastF}. Further, the fast-conversion logic unit 58 receives an external enable-close signal to stop outputting the first enable signal EN_{R} and the second enable signal EN_{F}, whereby the fast-conversion logic unit 58 can control whether to perform the transient state detection.

The voltage relationships of the first regulation voltage and the second regulation voltage in another four phases are respectively expressed by

$$XBR : {V}_{x 1} = {V}_{I N} , {V}_{x 2} = \frac{2 {V}_{O U T}}{3} ( as shown in FIG . 17 ) ;$$

$$XBF : {V}_{x 1} = G N D , {V}_{x 2} = {V}_{O U T} ( as shown in FIG . 18 ) ;$$

$$XOR : {V}_{x 1} = {V}_{I N} , {V}_{x 2} = GND ( as shown in FIG . 19 ) ;$$

$$XOF : {V}_{x 1} = \frac{2 {V}_{IN}}{3} , {V}_{x 2} = {V}_{O U T} ( as shown in FIG . 20 ) ,$$

wherein XBR is a first transient buck phase; XOR is a second transient buck phase; XBF is a first transient boost phase; XOF is a second transient boost phase.

Refer to FIG. 21. In some embodiments of the present invention, in the buck conversion mode or the fast buck conversion mode, while the conversion control unit 2 receives a transient buck signal (for example, the load current I_{LOAD} of the symmetric hybrid unit rises abruptly from 1 A to 2 A), the output voltage will drop abruptly with the change of the feedback signal V_{EA}, and a delayed feedback signal V_{EA_DELAY} will occur. Meanwhile, the transient state detection unit 5 will output a transient boost signal V_{FastR}, and the conversion control unit 2 controls the sequence of the phase variation of the first regulation voltage Vₓ₁ and the second regulation voltage Vₓ₂ as follows:

$$XBR \to {{φ}_{}}_{B} \to XBR \to {{φ}_{}}_{B}$$

whereby compensation may be performed in the abovementioned sequence during the appearance of the transient boost signal V_{FastR}.

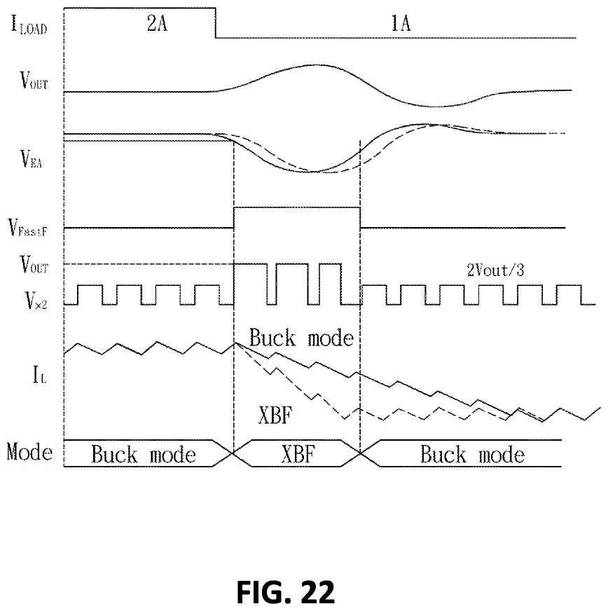

Refer to FIG. 22. In the buck conversion mode, while the conversion control unit 2 receives a transient boost signal (for example, the load current I_{LOAD} of the symmetric hybrid unit descends abruptly from 2 A to 1 A), the output voltage will rise abruptly with the change of the feedback signal V_{EA}, and a delayed feedback signal V_{EA_DELAY} will occur. Meanwhile, the transient state detection unit 5 will output a transient boost signal V_{FastR}, and the conversion control unit 2 controls the sequence of the phase variation of the first regulation voltage Vₓ₁ and the second regulation voltage Vₓ₂ as follows:

$${φ}_{A} \to X BF \to {φ}_{A} \to X B F$$

In the fast buck conversion mode, while the conversion control unit 2 receives a transient boost signal, the conversion control unit 2 controls the sequence of the phase variation of the first regulation voltage Vₓ₁ and the second regulation voltage Vₓ₂ as follows:

$${φ}_{C} \to X BF \to {φ}_{C} \to X B F$$

In the boost conversion mode, while the conversion control unit 2 receives a transient buck signal, the conversion control unit 2 controls the sequence of the phase variation of the first regulation voltage Vₓ₁ and the second regulation voltage Vₓ₂ as follows:

$${φ}_{A} \to XOR \to {φ}_{A} \to XOR$$

In the fast boost conversion mode, while the conversion control unit 2 receives a transient buck signal, the conversion control unit 2 controls the sequence of the phase variation of the first regulation voltage Vₓ₁ and the second regulation voltage Vₓ₂ as follows:

$${φ}_{E} \to XOR \to {φ}_{E} \to XOR$$

In the boost conversion mode or the fast boost conversion mode, while the conversion control unit 2 receives a transient boost signal, the conversion control unit 2 controls the sequence of the phase variation of the first regulation voltage Vₓ₁ and the second regulation voltage Vₓ₂ as follows:

$${φ}_{D} \to XOF \to {φ}_{D} \to XOF$$

The bidirectional hybrid power conversion system of the present invention further comprises a dead-zone compensation circuit 6. The dead-zone compensation circuit 6 is disposed between and connected with the conversion control unit 2 and the first conversion regulation circuit 10. The dead-zone compensation circuit 6 is also disposed between and connected to the conversion control unit 2 and the second conversion regulation circuit 12. The dead-zone compensation circuit 6 regulates the control signal to control the trigger timings of switching the first conversion regulation circuit 10 and the second conversion regulation circuit 12 to different phases.

In the symmetric hybrid unit 1, the combination of a plurality of transistors and capacitors may be used to form the first conversion regulation circuit 10 and the second conversion regulation circuit 12, whereby to reduce the difficulty of realizing the bidirectional hybrid power conversion system of the present invention. The symmetric hybrid unit 1 may further cooperate with the conversion control unit 2 and the feedback unit 3 to realize bidirectional voltage conversions at different conversion ratios. Thus, the conversion ratios of the present invention can meet USB PD 3.1. Further, the transient state detection unit 5 cooperates with the symmetric hybrid unit 1, the conversion control unit 2, and the feedback unit 3 to solve the problem of transient rise or drop of voltage in the transient state. Furthermore, the conversion control unit 2 and the feedback unit 3 are used to overcome the problems occurring in switching voltage conversion modes.

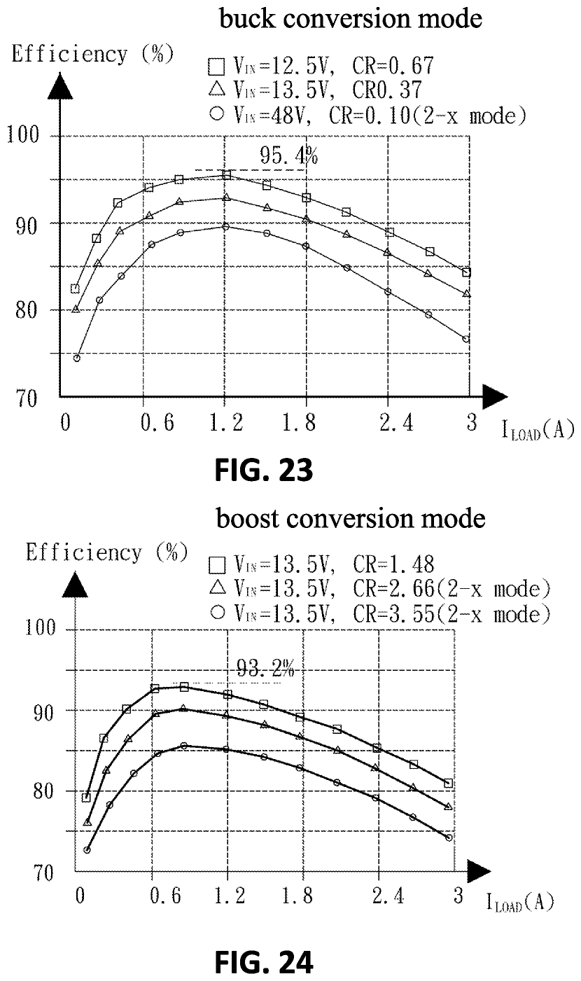

Refer to FIG. 23. In the buck conversion mode, the load current I_{LOAD} of the symmetric hybrid unit 1 is 1.2 A, and the input voltage V_{IN} is 13.5V, and the conversion ratio (CR) is 0.76; in such a case, the conversion efficiency is 95.4%. Refer to FIG. 24. In the boost conversion mode, the load current I_{LOAD} of the symmetric hybrid unit 1 is 1.2 A, and the input voltage V_{IN} is 13.5V, and the conversion ratio (CR) is 1.48; in such a case, the conversion efficiency is 93.2%. Therefore, the present invention has superior conversion efficiency.

The embodiments described above are only to exemplify the present invention but not to limit the scope of the present invention. Equivalent modifications or variations of these embodiments may be made by the persons skilled in the art without departing from the scope of the present invention and would be included by the scope of the present invention.

What is claimed is:

1. A bidirectional hybrid power conversion system, comprising
a symmetric hybrid unit, selecting to maintain or change a conversion ratio of voltage, receiving an input voltage, converting the input voltage into an output voltage at the conversion ratio;
a feedback unit, connected with the symmetric hybrid unit to receive the output voltage, comparing the output voltage with a reference voltage to generate a feedback signal; and
a conversion control unit, disposed between and connected with the symmetric hybrid unit and the feedback unit, receiving the feedback signal, the input voltage, and the output voltage, and comparing the feedback signal, the input voltage, and the output voltage to generate a control signal, wherein the conversion control unit controls the symmetric hybrid unit to select whether to maintain or change the conversion ratio according to the control signal.

2. The bidirectional hybrid power conversion system according to claim 1, wherein the symmetric hybrid unit includes a first conversion regulation circuit, a second conversion regulation circuit, and an intermediate circuit; the intermediate circuit is disposed between the first conversion regulation circuit and the second conversion regulation circuit; a maximum boost conversion ratio, which may be achieved by the first conversion regulation circuit, the intermediate circuit, and the second conversion regulation circuit, is expressed by an equation:
$$\frac{{V}_{O U T}}{{V}_{I N}} = C {R}_{2 - x boost} = \frac{2}{1 - D}$$
a maximum buck conversion ratio, which may be achieved by the first conversion regulation circuit, the intermediate circuit, and the second conversion regulation circuit, is expressed by an equation:
$$\frac{{V}_{OUT}}{{V}_{IN}} = {CR}_{2 - x buck} = \frac{D}{2}$$
wherein V_{OUT} is the output voltage; V_{IN} is the input voltage; CR_{2-x boost} is the maximum boost conversion ratio; CR_{2-x buck} is the maximum buck conversion ratio; D is a duty cycle of the first conversion regulation circuit and the second conversion regulation circuit; according to the control signal, the conversion control unit controls the conversion ratio of the symmetric hybrid unit to range between the maximum boost conversion ratio and the maximum buck conversion ratio.

3. The bidirectional hybrid power conversion system according to claim 2, wherein the feedback unit includes:
a multiplexer, connected with the first conversion regulation circuit and the second conversion regulation circuit, wherein while the first conversion regulation circuit functions as an output side, the multiplexer receives the voltage output by the first conversion regulation circuit; or, wherein while the second conversion regulation circuit functions as the output side, the multiplexer receives the voltage output by the second conversion regulation circuit;
a reference voltage generation circuit, generating the reference voltage; and
a comparator, connected with the multiplexer and the reference voltage generation circuit, receiving the reference voltage and the output voltage and comparing the reference voltage and the output voltage to output the feedback signal.

4. The bidirectional hybrid power conversion system according to claim 3, wherein a first regulation voltage exists between the first conversion regulation circuit and the intermediate circuit; a second regulation voltage exists between the second conversion regulation circuit and the intermediate circuit; voltage relationships of the first regulation voltage and the second regulation voltage in five different phases are respectively expressed by:
$${φ}_{A} : {V}_{x 1} = \frac{2 {V}_{IN}}{3} , {V}_{x 2} = \frac{2 {V}_{OUT}}{3} ;$$
$${φ}_{B} : {V}_{x 1} = GND , {V}_{x 2} = \frac{2 {V}_{OUT}}{3} ;$$
$${φ}_{C} : {V}_{x 1} = \frac{{V}_{IN}}{3} , {V}_{x 2} = \frac{2 {V}_{OUT}}{3} ;$$
$${φ}_{D} : {V}_{x 1} = \frac{2 {V}_{IN}}{3} , {V}_{x 2} = GND ; and$$
$${φ}_{E} : {V}_{x 1} = \frac{2 {V}_{IN}}{3} , {V}_{x 2} = \frac{{V}_{OUT}}{3} ;$$
wherein Vₓ₁ is the first regulation voltage; Vₓ₂ is the second regulation voltage; φ_{A} is a first phase; φ_{B} is a second phase; φ_{C} is a third phase; φ_{D} is a fourth phase; φ_{E} is the a phase; GND expresses grounding.

5. The bidirectional hybrid power conversion system according to claim 4, wherein
while the conversion control unit controls the first conversion regulation circuit, the intermediate circuit, and the second conversion regulation circuit to be in a boost conversion mode according to the control signal, variation of a phase of the first regulation voltage and the second regulation voltage is expressed by
$${φ}_{A} \to {φ}_{D} \to {φ}_{A} \to {φ}_{D}$$
while the control circuit controls the first conversion regulation circuit, the intermediate circuit, and the second conversion regulation circuit to be in a fast boost conversion mode according to the control signal, the variation of the phase of the first regulation voltage and the second regulation voltage is expressed by
$${φ}_{E} \to {φ}_{D} \to {φ}_{E} \to {φ}_{D}$$
while the control circuit controls the first conversion regulation circuit, the intermediate circuit, and the second conversion regulation circuit to be in a boost-buck conversion mode according to the control signal, the variation of the phase of the first regulation voltage and the second regulation voltage is expressed by
$${φ}_{A} \to {φ}_{B} \to {φ}_{A} \to {φ}_{D}$$
While the control circuit controls the first conversion regulation circuit, the intermediate circuit, and the second conversion regulation circuit to be in a buck conversion mode according to the control signal, the variation of the phase of the first regulation voltage and the second regulation voltage is expressed by
$${φ}_{A} \to {φ}_{B} \to {φ}_{A} \to {φ}_{B}$$
while the control circuit controls the first conversion regulation circuit, the intermediate circuit, and the second conversion regulation circuit to be in a fast buck conversion mode according to the control signal, the variation of the phase of the first regulation voltage and the second regulation voltage is expressed by
$${φ}_{C} \to {φ}_{B} \to {φ}_{C} \to {φ}_{B} .$$

6. The bidirectional hybrid power conversion system according to claim 3, wherein the intermediate circuit is an inductor; the maximum boost conversion ratio and the maximum buck conversion ratio are respectively expressed by equations:
$${CR}_{2 - x boost} = \frac{\frac{2}{3} {V}_{IN}}{H} \times D + \frac{\frac{2}{3} {V}_{IN} - \frac{1}{3} {V}_{OUT}}{H} \times ( 1 - D ) = 0$$
$${CR}_{2 - x buck} = \frac{\frac{1}{3} {V}_{IN} - \frac{2}{3} {V}_{OUT}}{H} \times D + \frac{- \frac{2}{3} {V}_{OUT}}{H} \times ( 1 - D ) = 0$$
wherein H is the inductance of the inductor.

7. The bidirectional hybrid power conversion system according to claim 5, wherein the conversion control unit includes
a ramp control circuit, connected with the feedback unit, and receiving an input reference signal, the feedback signal, a first clock signal, and a second clock signal, wherein the first clock signal is opposite to the second clock; according to the input reference signal, the first clock signal, and the second clock signal, the ramp control circuit generates a boost ramp signal and a buck ramp signal; in an identical cycle, a peak and a trough of a waveform of the boost ramp signal are opposite to a peak and a trough of a waveform of the buck ramp signal; and
a switching control circuit, connected with the symmetric hybrid unit and the ramp control circuit, wherein the switching control circuit receives the feedback signal, a buck comparison signal, a boost comparison signal, a current-mode signal, and a status confirmation signal;
wherein while the symmetric hybrid unit is in the buck conversion mode and the switching control circuit detects that the feedback signal reaches a peak value of the buck ramp signal, the switching control circuit switches the symmetric hybrid circuit to be in the boost-buck conversion mode; then, while the switching control circuit detects that the feedback signal exceeds the peak value of the buck ramp signal in two successive cycles, the switching control circuit switches the symmetric hybrid circuit to be in the boost conversion mode, wherein while the symmetric hybrid unit is in the boost conversion mode and the switching control circuit detects that the feedback signal reaches a trough value of the boost ramp signal, the switching control circuit switches the symmetric hybrid circuit to be in the boost-buck conversion mode; then, while the switching control circuit detects that the feedback signal is below the trough value of the boost ramp signal in two successive cycles, the switching control circuit switches the symmetric hybrid circuit to be in the buck conversion mode.

8. The bidirectional hybrid power conversion system according to claim 7, wherein the ramp control circuit includes a ramp generation circuit, a ramp comparison circuit, and a ramp control output circuit;
the ramp comparison circuit is disposed between and connected with the ramp generation circuit and the ramp control output circuit; according to the input reference signal, the first clock signal, and the second clock signal, the ramp generation circuit generates the boost ramp signal and the buck ramp signal;
the ramp comparison circuit compares the boost ramp signal and the feedback signal to generate the boost comparison signal; the ramp comparison circuit compares the buck ramp signal and the feedback signal to generate the buck comparison signal;
according to the boost comparison signal and the buck comparison signal, the ramp control output circuit generates the current-mode signal; the current-mode signal indicates whether the symmetric hybrid unit is in the boost conversion mode, the buck conversion mode, or the boost-buck conversion mode;
according to the boost comparison signal and the buck comparison signal, the ramp control output circuit generates a boost ramp regulation signal and a buck ramp regulation signal;
the ramp control output circuit transmits the boost ramp regulation signal and the buck ramp regulation signal to the ramp generation circuit; in an identical cycle, relationships of ramps, peak values, and trough values of the boost ramp signal and the buck ramp signal, which are generated by the ramp generation circuit, have three types of variations:
a normal mode: the trough value of the boost ramp signal is equal to the input reference signal; the peak value of the buck ramp signal is equal to the input reference signal;
a gentle mode: the trough value of the boost ramp signal is greater than the input reference signal; the peak value of the buck ramp signal is smaller than the input reference signal; and
a steep mode: the trough value of the boost ramp signal is smaller than the input reference signal; the peak value of the buck ramp signal is greater than the input reference signal,
wherein the ramps of the boost ramp signal and the buck ramp signal in the gentle mode are smaller than the ramps of the boost ramp signal and the buck ramp signal in the normal mode; the ramps of the boost ramp signal and the buck ramp signal in the steep mode are greater than the ramps of the boost ramp signal and the buck ramp signal in the normal mode.

9. The bidirectional hybrid power conversion system according to claim 8, wherein
while the switching control circuit indicates in the current-mode signal that the symmetric hybrid unit is in the boost conversion mode or the buck conversion mode, the switching control circuit controls the ramp generator circuit to induce the boost ramp signal is in the gentle mode, and the buck ramp signal is in the normal mode, in each cycle;
while the switching control circuit indicates in the current-mode signal that the symmetric hybrid unit turns from the boost conversion mode to the boost-buck conversion mode or turns from the buck conversion mode to the boost-buck conversion mode, the switching control circuit controls the ramp generator circuit to induce one of each two cycles has a combination of the boost ramp signal in the gentle mode and the buck ramp signal in the steep mode, another one of each two cycles has a combination of the boost ramp signal in the steep mode and the buck ramp signal in the gentle mode;
while the switching control circuit indicates in the current-mode signal that the symmetric hybrid unit is in the buck conversion pattern, the switching control circuit controls the ramp generator circuit to induce the boost ramp signal is in the normal mode, and the buck ramp signal is in the gentle mode, in each cycle.

10. The bidirectional hybrid power conversion system according to claim 9, wherein the conversion control unit includes a status confirmation circuit, wherein the status confirmation circuit receives the peak value of the buck ramp signal, the feedback signal, and the trough value of the boost ramp signal; the status confirmation circuit compares the peak value of the buck ramp signal and the feedback signal and compares the trough value of the boost ramp signal and the feedback signal to generate a status confirmation signal; while a potential of the feedback signal is gradually increasing or decreasing, the status confirmation signal does not change its state; while the potential of the feedback signal turns from rising into descending or from descending into rising, the potential of the status confirmation signal turns from a high level to a low level or from a low level to a high level.

11. The bidirectional hybrid power conversion system according to claim 10, wherein while the status confirmation signal changes and the switching control circuit indicates in the current-mode signal that the symmetric hybrid unit is still in the buck conversion mode, one of each two cycles has a combination of the boost ramp signal in the gentle mode and the buck ramp signal in the steep mode, and another one of each two cycles has a combination of the boost ramp signal in the steep mode and the buck ramp signal in the gentle mode.

12. The bidirectional hybrid power conversion system according to claim 5, further comprising a transient state detection unit, wherein the transient state detection unit is connected to the feedback unit and the conversion control unit; according to the feedback signal, the transient state detection unit outputs a transient boost signal or an transient buck signal to the conversion control unit; according to the transient boost signal or the transient buck signal, the conversion control unit controls the symmetric hybrid unit to vary the conversion ratio.

13. The bidirectional hybrid power conversion system according to claim 12, wherein the transient state detection unit receives the feedback signal and generates a delayed feedback signal according to the feedback signal; the transient state detection unit compares the feedback signal with the delayed feedback signal; while the feedback signal is greater than the delayed feedback signal, the transient state detection unit outputs the transient boost signal; while the feedback signal is smaller than the delayed feedback signal, the transient state detection unit outputs the transient buck signal.

14. The bidirectional hybrid power conversion system according to claim 12, wherein voltage relationships of the first regulation voltage and the second regulation voltage in another four phases are respectively expressed by
$$XBR , {V}_{x 1} = {V}_{IN} , {V}_{x 2} = \frac{2 {V}_{OUT}}{3} ;$$
$$XOR , {V}_{x 1} = {V}_{IN} , {V}_{x 2} = GND ;$$
$$XBF , {V}_{x 1} = GND , {V}_{x 2} = {V}_{OUT} ;$$
$$XOF , {V}_{x 1} = \frac{2 {V}_{IN}}{3} , {V}_{x 2} = {V}_{OUT} ;$$
wherein XBR is a first transient buck phase; XOR is a second transient buck phase; XBF is a first transient boost phase; XOF is a second transient boost phase.

15. The bidirectional hybrid power conversion system according to claim 14, wherein
in the buck conversion mode or the fast buck conversion mode, while the conversion control unit receives the transient buck signal, the conversion control unit controls the phases of the first regulation voltage and the second regulation voltage to vary according to a sequence:
$$XBR \to {φ}_{B} \to XBR \to {φ}_{B}$$
in the buck conversion mode, while the conversion control unit receives the transient boost signal, the conversion control unit controls the phases of the first regulation voltage and the second regulation voltage to vary according to a sequence:
$${φ}_{A} \to XBF \to {φ}_{A} \to XBF$$
in the fast buck conversion mode, while the conversion control unit receives the transient boost signal, the conversion control unit controls the phases of the first regulation voltage and the second regulation voltage to vary according to a sequence:
$${φ}_{C} \to XBF \to {φ}_{C} \to XBF$$
in the boost conversion mode, while the conversion control unit receives a transient buck signal, the conversion control unit controls the phases of the first regulation voltage and the second regulation voltage to vary according to a sequence:
$${φ}_{A} \to XOR \to {φ}_{A} \to XOR$$
in the fast boost conversion mode, while the conversion control unit receives a transient buck signal, the conversion control unit controls the phases of the first regulation voltage and the second regulation voltage to vary according to a sequence:
$${φ}_{E} \to XOR \to {φ}_{E} \to XOR$$
in the boost conversion mode or the fast boost conversion mode, while the conversion control unit receives a transient boost signal, the conversion control unit controls the phases of the first regulation voltage and the second regulation voltage to vary according to a sequence:
$${φ}_{D} \to XOF \to {φ}_{D} \to XOF .$$

16. The bidirectional hybrid power conversion system according to claim 5, further comprising a dead-zone compensation circuit, wherein the dead-zone compensation circuit is disposed between and connected to the conversion control unit and the first conversion regulation circuit; the dead-zone compensation circuit is also disposed between and connected with the conversion control unit and the second conversion regulation circuit; the dead-zone compensation circuit regulates the control signal to control the trigger timings of switching the first conversion regulation circuit and the second conversion regulation circuit to different phases.
